(19) United States
(12) Patent Application Publication
(10) Pub. No.: US 2021/0350826 A1
(43) Pub. Date: Nov. 11, 2021

(54) MAGNETIC RECORDING MEDIUM, MAGNETIC TAPE CARTRIDGE, AND MAGNETIC RECORDING AND REPRODUCING DEVICE

(71) Applicant: FUJIFILM Corporation, Tokyo (JP)

(72) Inventor: Masahiko MORI, Kanagawa (JP)

(73) Assignee: FUJIFILM Corporation, Tokyo (JP)

(21) Appl. No.: 17/241,078

(22) Filed: Apr. 27, 2021

(30) Foreign Application Priority Data
May 8, 2020 (JP) 2020-082670

(51) Int. Cl. G11B 5/706; G11B 5/008; G11B 5/714; G11B 5/735

(52) U.S. Cl. CPC G11B 5/70678; G11B 5/7356; G11B 5/714; G11B 5/00817

(57) ABSTRACT

The magnetic recording medium includes a non-magnetic support; a non-magnetic layer which contains a non-magnetic powder and is provided on the non-magnetic support; and a magnetic layer which contains a ferromagnetic powder and is provided on the non-magnetic layer, in which a thickness of the non-magnetic layer is less than 0.7 μm, and an average 5-point peak height Rpm is 30 nm or lower and the number of projections having a height of 5 nm or higher is 5,000 or more, as obtained by using an atomic force microscope in a measurement region of 90 μm square on a surface of the magnetic layer.

### CROSS-REFERENCE TO RELATED APPLICATIONS

This application claims priority under 35 U.S.C 119 to Japanese Patent Application No. 2020-082670 filed on May 8, 2020. The above application is hereby expressly incorporated by reference, in its entirety, into the present application.

### BACKGROUND OF THE INVENTION

### 1. Field of the Invention

The present invention relates to a magnetic recording medium, a magnetic tape cartridge, and a magnetic recording and reproducing device.

### 2. Description of the Related Art

As a magnetic recording medium, a magnetic recording medium, which has a non-magnetic layer containing a non-magnetic powder and a magnetic layer containing a ferromagnetic powder in this order on a non-magnetic support, is known (see, for example, JP2019-050067A, or the like).

### SUMMARY OF THE INVENTION

It is desired that a magnetic recording medium exhibits excellent electromagnetic conversion characteristics. Examples of a means for improving the electromagnetic conversion characteristics include increasing smoothness of a surface of a magnetic layer of a magnetic recording medium in order to reduce spacing loss. However, as the smoothness of the surface of the magnetic layer is increased, a friction coefficient tends to be high in a case where the surface of the magnetic layer and a magnetic head come into contact with each other and slide, for recording and/or reproducing data. Since a high friction coefficient may cause degradation in running stability (for example, occurrence of sticking between the surface of the magnetic layer and the magnetic head) and/or scraping of the surface of the magnetic layer, it is desirable to be able to reduce the friction coefficient. In the following, a low friction coefficient is also referred to as having excellent friction characteristics.

Regarding the matter, JP2019-050067A proposes to control surface physical properties measured by using an atomic force microscope in a measurement region of 5 μm square on the surface of the magnetic layer of the magnetic recording medium. JP2019-050067A describes that the electromagnetic conversion characteristics and the friction characteristics can be improved by controlling the surface physical properties as described above. Moreover, the present inventors have thought that it is necessary to aim at further improvement in the electromagnetic conversion characteristics as well as improvement in the friction characteristics, in order to respond to the recent needs for higher density recording.

One aspect of the present invention provides for a magnetic recording medium having excellent electromagnetic conversion characteristics and friction characteristics.

One aspect of the present invention relates to a magnetic recording medium comprising:

a non-magnetic support;

a non-magnetic layer which contains a non-magnetic powder and is provided on the non-magnetic support; and

a magnetic layer which contains a ferromagnetic powder and is provided on the non-magnetic layer,

in which a thickness of the non-magnetic layer is less than 0.7 μm, and

an average 5-point peak height Rpm is 30 nm or lower and the number of projections having a height of 5 nm or higher is 5,000 or more, as obtained by using an atomic force microscope in a measurement region of 90 μm square on a surface of the magnetic layer.

In one embodiment, the number of dark regions having an equivalent circle diameter of 300 μm or greater may be less than 5 per an area of 1,490 μm² in a binarized image of a backscattered electron image obtained by imaging the surface of the magnetic layer with a scanning electron microscope at an acceleration voltage of 2 kV.

In one embodiment, the magnetic layer may contain colloidal particles.

In one embodiment, the colloidal particles may be silica colloidal particles.

In one embodiment, the thickness of the non-magnetic layer may be 0.1 μm to 0.6 μm.

In one embodiment, the Rpm may be 15 nm to 30 nm.

In one embodiment, the number of projections having a height of 5 nm or higher may be 5,000 to 8,000.

In one embodiment, the magnetic recording medium may further comprise a back coating layer which contains a non-magnetic powder and is provided on a surface side of the non-magnetic support opposite to a surface side on which the non-magnetic layer and the magnetic layer are provided.

In one embodiment, the magnetic recording medium may be a magnetic tape.

Another aspect of the present invention relates to a magnetic tape cartridge comprising the aforementioned magnetic recording medium.

Still another aspect of the present invention relates to a magnetic recording and reproducing device comprising the aforementioned magnetic recording medium.

According to one aspect of the present invention, it is possible to provide a magnetic recording medium having excellent electromagnetic conversion characteristics and friction characteristics. Moreover, according to one aspect of the present invention, it is possible to provide a magnetic tape cartridge and a magnetic recording and reproducing device, which include the magnetic recording medium.

### DESCRIPTION OF THE PREFERRED EMBODIMENTS

Magnetic Recording Medium

One embodiment of the present invention relates to a magnetic recording medium including: a non-magnetic layer which contains a non-magnetic powder and is provided on a non-magnetic support; and a magnetic layer which contains a ferromagnetic powder and is provided on the non-magnetic layer. In the magnetic recording medium, a thickness of the non-magnetic layer is less than 0.7 μm, and an average 5-point peak height Rpm is 30 nm or lower and the number of projections having a height of 5 nm or higher is 5,000 or more, as obtained by using an atomic force microscope in a measurement region of 90 μm square on a surface of the magnetic layer.

Methods for Obtaining Various Numerical Values

Hereinafter, methods for obtaining the aforementioned various numerical values will be described.

Thickness of Non-Magnetic Layer

In the present invention and the present specification, the thickness of the non-magnetic layer is obtained by the following method using a cross-sectional image obtained by a scanning electron microscope (SEM).

(1) Production of Sample for Observing Cross Section

A sample for observing a cross section is produced by being cut out from a randomly determined position on a magnetic recording medium to be measured. The production of the sample for observing a cross section is performed by focused ion beam (FIB) processing using a gallium ion (Ga⁺) beam. Specific examples of such a production method will be described later with reference to Examples.

(2) Specification of Non-Magnetic Layer and Measurement of Thickness of Non-Magnetic Layer

The produced sample for observing a cross section is observed with SEM, and a cross-sectional image (SEM image) is captured. As the scanning electron microscope, a field emission-scanning electron microscope (FE-SEM) is used. For example, FE-SEM S4800 manufactured by Hitachi, Ltd. can be used, and the FE-SEM is used in Examples which will be described later.

SEM images are captured at randomly selected positions in the same sample for observing a cross section, except that the positions are selected so that (i) the imaging ranges do not overlap, (ii) an interface between a magnetic layer and a non-magnetic layer fits on the SEM image, and (iii) an interface between a non-magnetic layer and a non-magnetic support fits on the SEM image, and a total of 10 images are obtained.

The SEM images are secondary electron images (SE images) captured at an acceleration voltage of 5 kV, an imaging magnification of 100,000 times, and vertical 960 pixels×horizontal 1,280 pixels.

The captured SEM image is taken into WinROOF which is manufactured by MITANI CORPORATION and is image processing software, and a portion (measurement region) of a non-magnetic layer in the SEM image is selected. In the selection of the measurement region, a length of the measurement region in a width direction is taken as a total width of the captured SEM image. Moreover, the “width direction” described in relation to the SEM image refers to a width direction in the imaged sample for observing a cross section. The width direction in the sample for observing a cross section is a width direction in a magnetic recording medium from which the sample is cut out. The same also applies to a thickness direction.

Regarding the thickness direction, the interface between the magnetic layer and the non-magnetic layer is specified by the following method. The SEM image is digitized to create image brightness data (consisting of three components: a coordinate in the thickness direction; a coordinate in the width direction; and a brightness) in the thickness direction. In the digitization, the SEM image is divided into 1,280 pieces in the width direction, and processed with a brightness of 8 bits to obtain 256-gradation data, and the image brightness of each divided coordinate point is converted into a predetermined gradation value. Next, a brightness curve is created by setting an average value (that is, an average value of brightnesses at respective coordinate points divided into 1,280 pieces) of brightnesses in the width direction at respective coordinate points in the thickness direction in the obtained image brightness data to a vertical axis, and setting a coordinate in the thickness direction to a horizontal axis. The created brightness curve is differentiated to create a differential curve, and a coordinate of a boundary between the magnetic layer and the non-magnetic layer is specified from a peak position of the created differential curve. A position corresponding to the specified coordinate on the SEM image is taken as the interface between the magnetic layer and the non-magnetic layer.

Regarding the interface between the non-magnetic layer and the non-magnetic support, for example, in the coating-type magnetic recording medium, the interface between the non-magnetic layer and the non-magnetic support is clearly recognizable, compared to the interface between the magnetic layer and non-magnetic layer. Therefore, the interface between the non-magnetic layer and the non-magnetic support can be specified by visually observing the SEM image. However, the interface may be specified by using the brightness curve in the same manner as above. Moreover, in Examples which will be described later, the interface between the non-magnetic layer and the non-magnetic support was specified through visual observation.

The entire region including the interface (that is, the surface of the non-magnetic layer on the magnetic layer side) between the magnetic layer and non-magnetic layer and the interface (that is, the surface of the non-magnetic layer on the non-magnetic support side) between the non-magnetic layer and the non-magnetic support, which are specified as described above, is specified as a non-magnetic layer.

Regarding the measurement region specified above as the non-magnetic layer, an interval between the both interfaces, which are specified as described above, in the thickness direction is obtained at any one position on each SEM image, and an arithmetic mean of values obtained for 10 images is taken as the thickness of the non-magnetic layer. Thicknesses of other layers, such as the magnetic layer, and the non-magnetic support can also be obtained by the same method. Alternatively, the thicknesses of the other layers may be obtained as designed thicknesses calculated from the manufacturing conditions.

Average 5-Point Peak Height Rpm and Number of Projections Having Height of 5 nm or Higher

In the present invention and the present specification, the average 5-point peak height Rpm and the number of projections having a height of 5 nm or higher are both obtained by measurement using an atomic force microscope (AFM). Specifically, from a plane image of the surface of the magnetic layer obtained using the AFM, a maximum height Rp1, a second-highest height Rp2, a third-highest height Rp3, a fourth-highest height Rp4, and a fifth-highest height Rp5 are obtained according to a method for measuring 10-spot average roughness Rz specified in JIS B 0601:1994, and an arithmetic mean thereof, that is, the Rpm is calculated as (Rp1+Rp2+Rp3+Rp4+Rp5)/5. Moreover, the 10-spot average roughness Rz is the sum of an arithmetic mean of heights from the maximum height to the fifth-highest height and an arithmetic mean of depths from the deepest depth to the fifth-deepest depth.

Meanwhile, regarding the number of projections, in the plane image obtained by the AFM, a surface in the measurement region where volumes of a convex component and a concave component are equal is defined as a reference surface, and the number of projections having a height of 5 nm or higher from the reference surface is obtained. Moreover, among the projections which have a height of 5 nm or higher and are present in the measurement region, there may be projections in which a part is inside the measurement region and the other part is outside the measurement region. In a case of obtaining the number of projections, the number of projections including such projections is measured.

The measurement region in the measurement using the AFM is taken as a region of 90 μm square (90 m×90 m) on the surface of the magnetic layer. The measurement is performed for three different measurement regions on the surface of the magnetic layer (N=3). The average 5-point peak height Rpm and the number of projections having a height of 5 nm or higher are obtained as an arithmetic mean of three values obtained through such measurement. As an example of the measurement conditions for the AFM, the following measurement conditions can be mentioned.

An AFM (Dimension FastScan manufactured by BRUKER) measures a region of 90 μm square (90 m×90 m) on the surface of the magnetic layer of the magnetic recording medium by using a ScanAsyst mode. ScanAsyst-AIR manufactured by BRUKER is used as a probe, a resolution is set to 1,024 pixels×1,024 pixels, and a scan speed (probe movement speed) is set to 22.8 μm/sec.

In the magnetic recording medium according to the embodiment of the present invention, the average 5-point peak height Rpm is 30 nm or lower and the number of projections having a height of 5 nm or higher is 5,000 or more, as obtained by using the atomic force microscope in the measurement region of 90 μm square on the surface of the magnetic layer. Through repeated studies, the present inventors have thought that reducing coarse projections, which are rarely present on the surface of the magnetic layer and are difficult to detect in the measurement region (5 μm square) described in JP2019-050067A, is effective for further improving the electromagnetic conversion characteristics. Moreover, as a result of further repeating intensive studies, the present inventors have concluded that the fact in which the average 5-point peak height Rpm obtained by using the atomic force microscope in a measurement region wider than the measurement region in JP2019-050067A, that is, in a measurement region of 90 μm square on the surface of the magnetic layer is 30 nm or lower indicates that such coarse projections are reduced.

In addition, regarding the friction characteristics, the present inventors have thought that causing the number of projections having a height of 5 nm or higher obtained by the aforementioned method in the surface of the magnetic layer having an Rpm of 30 nm or lower to be 5,000 or more contributes to the improvement in the friction characteristics. Moreover, the present inventors have thought that setting the thickness of the non-magnetic layer to be less than 0.7 μm is effective for causing the number of projections to be 5,000 or more.

However, the present invention is not limited to inferences of the present inventors including the above matters.

Hereinafter, the magnetic recording medium will be described in more detail. Moreover, in the present invention and the present specification, the “powder” means an aggregate of a plurality of particles. For example, the ferromagnetic powder is an aggregate of a plurality of ferromagnetic particles, and the non-magnetic powder is an aggregate of a plurality of non-magnetic particles. The “aggregate” is not limited to one embodiment in which particles constituting the aggregate directly are in direct contact with each other, and also includes one embodiment in which a binding agent, an additive, or the like is interposed between the particles. The term “particles” may be used for representing an aggregate (that is, a powder) of particles. Moreover, in the present invention and the present specification, the “surface of the magnetic layer” has the same meaning as the surface of the magnetic recording medium on the magnetic layer side.

Regarding particle sizes of various powders, in the present invention and the present specification, an average particle size is a value measured by the following method with a transmission electron microscope, unless otherwise noted.

The powder is imaged at an imaging magnification of 100,000 times with a transmission electron microscope, and the image is printed on photographic printing paper or displayed on a display so that the total magnification is 500,000 times, to obtain a photograph of particles constituting the powder. A target particle is selected from the obtained photograph of particles, an outline of the particle is traced with a digitizer, and a size of the particle (primary particle) is measured. The primary particle refers to independent particles which are not aggregated.

The aforementioned measurement is performed for randomly selected 500 particles. An arithmetic mean of the particle sizes of 500 particles obtained as described above is an average particle size of the powders. As the transmission electron microscope, a transmission electron microscope H-9000 manufactured by Hitachi, Ltd. can be used, for example. Furthermore, the measurement of the particle size can be performed by using well-known image analysis software, for example, image analysis software KS-400 manufactured by Carl Zeiss. Each average particle size shown in Examples which will be described later is a value measured by using the transmission electron microscope H-9000 manufactured by Hitachi, Ltd. as the transmission electron microscope, and using the image analysis software KS-400 manufactured by Carl Zeiss as the image analysis software.

In the present invention and the present specification, unless otherwise noted,

(1) in a case where the shape of the particle observed in the aforementioned particle photograph is a needle shape, a fusiform shape, or a columnar shape (here, a height is greater than a maximum long diameter of a bottom surface), the particle size of each particle constituting the powder is shown as a length of a long axis constituting the particle, that is, a long axis length,

(2) in a case where the shape of the particle is a plate shape or a columnar shape (here, a thickness or a height is less than a maximum long diameter of a plate surface or a bottom surface), the particle size is shown as a maximum long diameter of the plate surface or the bottom surface, and

(3) in a case where the shape of the particle is a spherical shape, a polyhedron shape, or an unspecified shape, and the long axis constituting the particles cannot be specified from the shape, the particle size is shown as an equivalent circle diameter. The equivalent circle diameter refers to a value obtained by a circle projection method.

Furthermore, unless otherwise noted, in a case of definition (1) of the particle size, the average particle size is an average long axis length, and in a case of the definition (2) thereof, the average particle size is an average plate diameter. In a case of the definition (3) thereof, the average particle size is an average diameter (also referred to as an average particle diameter).

In addition, in the present invention and the present specification, a specific surface area of the powder is a specific surface area obtained by using the Brunauer-Emmett-Teller (BET) equation derived by Brunauer, Emmett, and Teller by means of a nitrogen adsorption method according to JIS K 6217-7:2013. The specific surface area obtained as described above can be an index of the particle sizes of primary particles of particles constituting the powder. It can be considered that the larger the specific surface area, the smaller the particle sizes of the primary particles of the particles constituting the powder. Each specific surface area of various powders used in Examples and Comparative Examples, which will be described later, is a specific surface area measured for a raw material powder used in the preparation of an each layer-forming composition. However, it is also possible to extract a powder from the magnetic recording medium by a well-known method, and obtain a specific surface area of the extracted powder.

Magnetic Layer

Average 5-Point Peak Height Rpm

In the magnetic recording medium, the average 5-point peak height Rpm obtained by using the atomic force microscope in the measurement region of 90 μm square on the surface of the magnetic layer is 30 nm or lower, preferably 28 nm or lower, more preferably 26 nm or lower, and even more preferably 22 nm or lower, from a viewpoint of improving electromagnetic conversion characteristics. For example, the Rpm can be 10 nm or higher, 12 nm or higher, or 15 nm or higher, and can also be lower than the value exemplified above. It is preferable that the Rpm value is low, from a viewpoint of further improving the electromagnetic conversion characteristics.

Number of Projections Having Height of 5 nm or Higher

In the magnetic recording medium, the number of projections having a height of 5 nm or higher obtained by using the atomic force microscope in the measurement region of 90 μm square on the surface of the magnetic layer is 5,000 or more, preferably 5,100 or more, and more preferably 5,200 or more, 5,300 or more, 5,400 or more, and 5,500 or more in this order, from a viewpoint of improving friction characteristics. For example, the number of projections can be 8,000 or less, 7,500 or less, or 7,000 or less, and can also be more than the value exemplified above. From a viewpoint of improving the friction characteristics, it is preferable that the number of projections is large.

A means for controlling the Rpm value and the number of projections will be described later.

Ferromagnetic Powder

The ferromagnetic powder contained in the magnetic layer of the magnetic recording medium can be preferably a ferromagnetic powder selected from the group consisting of a hexagonal ferrite powder and an ε-iron oxide powder. The hexagonal ferrite powder and the ε-iron oxide powder are said to be preferable ferromagnetic powders, from a viewpoint of improving recording density of the magnetic recording medium. For example, the magnetic layer of the magnetic recording medium may contain one kind alone or two or more kinds of ferromagnetic powders selected from the group consisting of a hexagonal ferrite powder and an ε-iron oxide powder.

It is preferable to use a ferromagnetic powder having a small average particle size as the ferromagnetic powder contained in the magnetic layer of the magnetic recording medium, from a viewpoint of improving recording density. From the viewpoint, the average particle size of the ferromagnetic powders is preferably 50 nm or smaller, more preferably 45 nm or smaller, even more preferably 40 nm or smaller, still preferably 35 nm or smaller, still more preferably 30 nm or smaller, still even more preferably 25 nm or smaller, and further preferably 20 nm or smaller. Meanwhile, from a viewpoint of magnetization stability, the average particle size of the ferromagnetic powders is preferably 5 nm or larger, more preferably 8 nm or larger, even more preferably 10 nm or larger, still preferably 15 nm or larger, and still more preferably 20 nm or larger.

Hexagonal Ferrite Powder

In one embodiment, the magnetic recording medium may contain a hexagonal ferrite powder in the magnetic layer. For details of the hexagonal ferrite powder, the descriptions disclosed in paragraphs 0012 to 0030 of JP2011-225417A, paragraphs 0134 to 0136 of JP2011-216149A, paragraphs 0013 to 0030 of JP2012-204726A, and paragraphs 0029 to 0084 of JP2015-127985A can be referred to, for example.

In the present invention and the present specification, the “hexagonal ferrite powder” refers to a ferromagnetic powder in which a hexagonal ferrite-type crystal structure is detected as a main phase by X-ray diffraction analysis. The main phase refers to a structure to which a diffraction peak of the highest intensity in an X-ray diffraction spectrum obtained by the X-ray diffraction analysis belongs. For example, in a case where the diffraction peak of the highest intensity in the X-ray diffraction spectrum obtained by the X-ray diffraction analysis belongs to a hexagonal ferrite-type crystal structure, it is determined that the hexagonal ferrite-type crystal structure is detected as a main phase. In a case where only a single structure is detected by the X-ray diffraction analysis, this detected structure is used as a main phase. The hexagonal ferrite-type crystal structure includes at least an iron atom, a divalent metal atom, and an oxygen atom as constituting atoms. The divalent metal atom is a metal atom which can be a divalent cation as an ion, and examples thereof include an alkaline earth metal atom such as a strontium atom, a barium atom, or a calcium atom, and a lead atom. In the present invention and the present specification, the hexagonal strontium ferrite powder refers to a powder in which a main divalent metal atom contained in this powder is a strontium atom, and the hexagonal barium ferrite powder refers to a powder in which a main divalent metal atom contained in this powder is a barium atom. Moreover, the hexagonal cobalt ferrite powder refers to a powder in which a main divalent metal atom contained in this powder is a cobalt atom. The main divalent metal atom refers to a divalent metal atom occupying the largest part based on atom %, among the divalent metal atoms contained in the powder. Here, the aforementioned divalent metal atom does not include a rare earth atom.

The “rare earth atom” in the present invention and the present specification is selected from the group consisting of a scandium atom (Sc), an yttrium atom (Y), and a lanthanoid atom. The lanthanoid atom is selected from the group consisting of a lanthanum atom (La), a cerium atom (Ce), a praseodymium atom (Pr), a neodymium atom (Nd), a promethium atom (Pm), a samarium atom (Sm), a europium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

As the hexagonal ferrite powder, one or more kinds selected from the group consisting of a hexagonal strontium ferrite powder, a hexagonal barium ferrite powder, and a hexagonal cobalt ferrite powder can be used. From a viewpoint of improving the recording density of the magnetic recording medium, a hexagonal strontium ferrite powder is preferable.

Hereinafter, the hexagonal strontium ferrite powder which is one embodiment of the hexagonal ferrite powder will be described in more detail. At least some of the matters described below for the hexagonal strontium ferrite powder may also be applied to the hexagonal barium ferrite powder and the hexagonal cobalt ferrite powder.

An activation volume of the hexagonal strontium ferrite powder is preferably in a range of 800 to 1,600 nm³. The atomized hexagonal strontium ferrite powder having an activation volume within the above range is suitable for producing a magnetic recording medium exhibiting excellent electromagnetic conversion characteristics. The activation volume of the hexagonal strontium ferrite powder is preferably 800 nm³ or greater, and can be, for example, 850 nm³ or greater. Moreover, from a viewpoint of further improving the electromagnetic conversion characteristics, the activation volume of the hexagonal strontium ferrite powder is more preferably 1,500 nm³ or less, even more preferably 1,400 nm³ or less, still preferably 1,300 nm³ or less, still more preferably 1,200 nm³ or less, and still even more preferably 1,100 nm³ or less. The same also applies to an activation volume of the hexagonal barium ferrite powder.

The “activation volume” is a unit of magnetization reversal, and is an index indicating a magnetic size of a particle. The activation volume and an anisotropy constant Ku, which will be described later, described in the present invention and the present specification are values obtained from the following relational expression between He and an activation volume V, after magnetic field sweep rates of a coercivity He measurement part at time points of 3 minutes and 30 minutes are measured by using a vibrating sample magnetometer (measurement temperature: 23° C.±1° C.). Regarding a unit of the anisotropy constant Ku, 1 erg/cc=1.0×10⁻¹ J/m³.

Hc=2Ku/Ms{1−[(kT/KuV)ln(At/0.693)]^{1/2}}

[In the expression, Ku: anisotropy constant (unit: J/m³), Ms: saturation magnetization (unit: kA/m), k: Boltzmann's constant, T: absolute temperature (unit: K), V: activation volume (unit: cm³), A: spin precession frequency (unit: s⁻¹), and t: magnetic field reversal time (unit: s)]

The anisotropy constant Ku can be used as an index of reduction of thermal fluctuation, that is, improvement in thermal stability. The hexagonal strontium ferrite powder can preferably have a Ku of 1.8×10⁵ J/m³ or greater, and more preferably have a Ku of 2.0×10⁵ J/m³ or greater. Moreover, the Ku of the hexagonal strontium ferrite powder can be, for example, 2.5×10⁵ J/m³ or less. However, since a higher Ku means higher thermal stability and thus is preferable, the Ku is not limited to the value exemplified above.

The hexagonal strontium ferrite powder may or may not contain a rare earth atom. In a case where the hexagonal strontium ferrite powder contains the rare earth atom, a content ratio (bulk content ratio) of the rare earth atom is preferably 0.5 to 5.0 atom % with respect to 100 atom % of the iron atom. In one embodiment, the hexagonal strontium ferrite powder containing the rare earth atom can have rare earth atomic uneven distribution in the surface layer portion. The “rare earth atomic uneven distribution in the surface layer portion” in the present invention and the present specification means that a content ratio (hereinafter, referred to as a “rare earth atom content ratio in the surface layer portion” or simply a “content ratio in the surface layer portion” regarding the rare earth atom) of the rare earth atom with respect to 100 atom % of an iron atom in a solution obtained by partially dissolving the hexagonal strontium ferrite powder with acid and a content ratio (hereinafter, referred to as a “rare earth atom bulk content ratio” or simply a “bulk content ratio” regarding the rare earth atom) of the rare earth atom with respect to 100 atom % of an iron atom in a solution obtained by totally dissolving the hexagonal strontium ferrite powder with acid satisfy a ratio of rare earth atom content ratio in the surface layer portion/rare earth atom bulk content ratio >1.0. The content ratio of the rare earth atom of the hexagonal strontium ferrite powder which will be described later has the same meaning as the rare earth atom bulk content ratio. In contrast, the partial dissolving using acid is to dissolve the surface layer portions of particles constituting the hexagonal strontium ferrite powder, and accordingly, the content ratio of the rare earth atom in the solution obtained by the partial dissolving is the content ratio of the rare earth atom in the surface layer portions of the particles constituting the hexagonal strontium ferrite powder. The fact in which the rare earth atom content ratio in the surface layer portion satisfies a ratio of “rare earth atom content ratio in the surface layer portion/rare earth atom bulk content ratio >1.0” means that the rare earth atoms are unevenly distributed in the surface layer portion (that is, a larger amount of the rare earth atoms is present, compared to that inside) in the particles constituting the hexagonal strontium ferrite powder. The surface layer portion in the present invention and the present specification means a partial region of the particles constituting the hexagonal strontium ferrite powder towards the inside from the surface.

In a case where the hexagonal strontium ferrite powder contains the rare earth atom, a content ratio (bulk content ratio) of the rare earth atom is preferably in a range of 0.5 to 5.0 atom % with respect to 100 atom % of the iron atom. It is thought that the fact in which the rare earth atom is contained in a bulk content ratio within the above range and the rare earth atoms are unevenly distributed in the surface layer portions of the particles constituting the hexagonal strontium ferrite powder contribute to the prevention of reduction of reproduction output during the repeated reproduction. It is inferred that this is because the anisotropy constant Ku can be increased due to the hexagonal strontium ferrite powder containing the rare earth atom in a bulk content ratio within the above range and uneven distribution of the rare earth atoms in the surface layer portions of the particles constituting the hexagonal strontium ferrite powder. As the value of the anisotropy constant Ku is high, occurrence of a phenomenon, which is referred to as so-called thermal fluctuation, can be prevented (that is, thermal stability can be improved). By preventing the occurrence of thermal fluctuation, it is possible to prevent reduction of the reproduction output during the repeated reproduction. It is inferred that the uneven distribution of the rare earth atom in the surface layer portion of the particle of the hexagonal strontium ferrite powder contributes to stabilization of a spin at an iron (Fe) site in a crystal lattice of the surface layer portion, thereby increasing the anisotropy constant Ku.

In addition, it is inferred that the use of the hexagonal strontium ferrite powder having the rare earth atomic uneven distribution in the surface layer portion as the ferromagnetic powder of the magnetic layer contributes to the prevention of scraping of the surface on the magnetic layer side due to the sliding with the magnetic head. That is, it is inferred that the hexagonal strontium ferrite powder having the rare earth atomic uneven distribution in the surface layer portion can also contribute to the improvement in running durability of the magnetic recording medium. It is inferred that this is because the uneven distribution of the rare earth atoms on the surfaces of the particles constituting the hexagonal strontium ferrite powder contributes to improvement in an interaction between the surface of the particles and an organic substance (for example, binding agent and/or additive) contained in the magnetic layer, thereby improving hardness of the magnetic layer.

From a viewpoint of further preventing reduction of the reproduction output in the repeated reproduction and/or a viewpoint of further improving running durability, the content ratio (bulk content ratio) of the rare earth atom is more preferably in a range of 0.5 to 4.5 atom %, even more preferably in a range of 1.0 to 4.5 atom %, and still preferably in a range of 1.5 to 4.5 atom %.

The bulk content ratio is a content ratio obtained by totally dissolving the hexagonal strontium ferrite powder. In the present invention and the present specification, the content ratio of the atom contained in the hexagonal strontium ferrite powder refers to a bulk content ratio obtained by totally dissolving the hexagonal strontium ferrite powder, unless otherwise noted. The hexagonal strontium ferrite powder containing the rare earth atom may contain only one kind of rare earth atom or may contain two or more kinds of rare earth atoms, as the rare earth atom. In a case where two or more kinds of rare earth atoms are contained, the bulk content ratio is obtained for the total of the two or more kinds of rare earth atoms. The same also applies to other components in the present invention and the present specification. That is, for a given component, only one kind thereof may be used or two or more kinds thereof may be used, unless otherwise noted. In a case where two or more kinds thereof are used, the content or content ratio is a content or content ratio of the total of the two or more kinds thereof.

In a case where the hexagonal strontium ferrite powder contains the rare earth atom, the rare earth atom contained therein may be any one or more kinds of the rare earth atoms. Examples of the rare earth atom, which is preferable from a viewpoint of further preventing reduction of the reproduction output during the repeated reproduction, include a neodymium atom, a samarium atom, an yttrium atom, and a dysprosium atom, a neodymium atom, a samarium atom, and an yttrium atom are more preferable, and a neodymium atom is even more preferable.

In the hexagonal strontium ferrite powder having the rare earth atomic uneven distribution in the surface layer portion, a degree of uneven distribution of the rare earth atoms is not limited, as long as the rare earth atoms are unevenly distributed in the surface layer portions of the particles constituting the hexagonal strontium ferrite powder. For example, regarding the hexagonal strontium ferrite powder having the rare earth atomic uneven distribution in the surface layer portion, “content ratio in the surface layer portion/bulk content ratio”, which is a ratio of the content ratio in the surface layer portion of the rare earth atom obtained by partial dissolving performed under the dissolving conditions which will be described later to the bulk content ratio of the rare earth atom obtained by total dissolving performed under the dissolving conditions which will be described later, is greater than 1.0 and can be 1.5 or greater. The “content ratio in the surface layer portion/bulk content ratio” of greater than 1.0 means that the rare earth atoms are unevenly distributed in the surface layer portions (that is, a larger amount of the rare earth atoms is present, compared to that inside) in the particles constituting the hexagonal strontium ferrite powder. Furthermore, “content ratio in the surface layer portion/bulk content ratio”, which is the ratio of the content ratio in the surface layer portion of the rare earth atom obtained by partial dissolving performed under the dissolving conditions which will be described later to the bulk content ratio of the rare earth atom obtained by total dissolving performed under the dissolving conditions which will be described later, can be, for example, 10.0 or less, 9.0 or less, 8.0 or less, 7.0 or less, 6.0 or less, 5.0 or less, or 4.0 or less. However, in the hexagonal strontium ferrite powder having the rare earth atomic uneven distribution in the surface layer portion, the “content ratio in the surface layer portion/bulk content ratio” is not limited to the exemplified upper limit or lower limit, as long as the rare earth atoms are unevenly distributed in the surface layer portions of the particles constituting the hexagonal strontium ferrite powder.

The partial dissolving and the total dissolving of the hexagonal strontium ferrite powder will be described below. Regarding the hexagonal strontium ferrite powder present as a powder, sample powders for the partial dissolving and the total dissolving are collected from the powders of the same lot. Meanwhile, regarding the hexagonal strontium ferrite powder contained in the magnetic layer of the magnetic recording medium, a part of the hexagonal strontium ferrite powders extracted from the magnetic layer is subjected to the partial dissolving and the other part is subjected to the total dissolving. The extraction of the hexagonal strontium ferrite powder from the magnetic layer can be performed, for example, by a method described in paragraph 0032 of JP2015-091747A.

The partial dissolving refers to dissolving performed so that the hexagonal strontium ferrite powder remaining in the solution can be visually confirmed at the time of the completion of the dissolving. For example, by performing the partial dissolving, 10% to 20% by mass of the region of the particles constituting the hexagonal strontium ferrite powder with respect to 100% by mass of a total of the particles can be dissolved. On the other hand, the total dissolving refers to dissolving performed until the hexagonal strontium ferrite powder remaining in the solution is not visually confirmed at the time of the completion of the dissolving.

The partial dissolving and the measurement of the content ratio in the surface layer portion are, for example, performed by the following method. However, the following dissolving conditions such as an amount of a sample powder are merely examples, and dissolving conditions capable of performing the partial dissolving and the total dissolving can be randomly used.

A vessel (for example, a beaker) containing 12 mg of a sample powder and 10 mL of hydrochloric acid having a concentration of 1 mol/L is held on a hot plate at a set temperature of 70° C. for 1 hour. The obtained solution is filtered with a membrane filter of 0.1 m. The element analysis of the filtrate obtained as described above is performed by an inductively coupled plasma (ICP) analysis device. By doing so, the content ratio in the surface layer portion of the rare earth atom with respect to 100 atom % of the iron atom can be obtained. In a case where a plurality of kinds of rare earth atoms are detected from the element analysis, a total content ratio of all the rare earth atoms is taken as the content ratio in the surface layer portion. The same also applies to the measurement of the bulk content ratio.

Meanwhile, the total dissolving and the measurement of the bulk content ratio are, for example, performed by the following method.

A vessel (for example, a beaker) containing 12 mg of a sample powder and 10 mL of hydrochloric acid having a concentration of 4 mol/L is held on a hot plate at a set temperature of 80° C. for 3 hours. Thereafter, the bulk content ratio with respect to 100 atom % of the iron atom can be obtained by performing the processes in the same manner as in the partial dissolving and the measurement of the content ratio in the surface layer portion.

From a viewpoint of increasing reproducing output in a case of reproducing data recorded on a magnetic recording medium, it is desirable that a mass magnetization as of the ferromagnetic powder contained in the magnetic recording medium is high. In regards to this matter, in a hexagonal strontium ferrite powder which contains a rare earth atom but does not have rare earth atomic uneven distribution in the surface layer portion, the as tends to be significantly decreased, compared to that in a hexagonal strontium ferrite powder not containing the rare earth atom. With respect to this, it is thought that the hexagonal strontium ferrite powder having the rare earth atomic uneven distribution in the surface layer portion is preferable for preventing such a significant decrease in the as. In one embodiment, the as of the hexagonal strontium ferrite powder can be 45 A·m²/kg or greater and can also be 47 A·m²/kg or greater. Meanwhile, from a viewpoint of noise reduction, the as is preferably 80 A·m²/kg or less and more preferably 60 A·m²/kg or less. The as can be measured by using a well-known measurement device capable of measuring magnetic characteristics, such as a vibrating sample magnetometer. In the present invention and the present specification, the mass magnetization as is a value measured at a magnetic field strength of 15 kOe, unless otherwise noted.

Regarding the content ratio (bulk content ratio) of the constituting atom in the hexagonal strontium ferrite powder, a content ratio of the strontium atom can be, for example, in a range of 2.0 to 15.0 atom % with respect to 100 atom % of the iron atom. In one embodiment, in the hexagonal strontium ferrite powder, only a strontium atom can be used as the divalent metal atom contained in this powder. Moreover, in another form, the hexagonal strontium ferrite powder can also contain one or more kinds of other divalent metal atoms, in addition to the strontium atom. For example, a barium atom and/or a calcium atom may be contained. In a case where the other divalent metal atom other than the strontium atom is contained, a content ratio of a barium atom and a content ratio of a calcium atom in the hexagonal strontium ferrite powder can each be, for example, in a range of 0.05 to 5.0 atom % with respect to 100 atom % of the iron atom.

As the crystal structure of the hexagonal ferrite, a magnetoplumbite type (also referred to as an “M type”), a W type, a Y type, and a Z type are known. The hexagonal strontium ferrite powder may have any crystal structure. The crystal structure can be confirmed by X-ray diffraction analysis. In the hexagonal strontium ferrite powder, a single crystal structure or two or more kinds of crystal structures can be detected by the X-ray diffraction analysis. For example, in one embodiment, in the hexagonal strontium ferrite powder, only the M-type crystal structure can be detected by the X-ray diffraction analysis. For example, the M-type hexagonal ferrite is represented by a compositional formula of AFe₁₂O₁₉. Here, in a case where A represents a divalent metal atom and the hexagonal strontium ferrite powder has the M-type, only a strontium atom (Sr) is used as A, or in a case where a plurality of divalent metal atoms are contained as A, the strontium atom (Sr) occupies the largest part based on atom % as described above. A content ratio of the divalent metal atom in the hexagonal strontium ferrite powder is generally determined according to the type of the crystal structure of the hexagonal ferrite and is not particularly limited. The same also applies to a content ratio of an iron atom and a content ratio of an oxygen atom. The hexagonal strontium ferrite powder at least contains an iron atom, a strontium atom, and an oxygen atom, and may further contain a rare earth atom. Moreover, the hexagonal strontium ferrite powder may or may not contain atoms other than these atoms. As an example, the hexagonal strontium ferrite powder may contain an aluminum atom (Al). A content ratio of the aluminum atom can be, for example, 0.5 to 10.0 atom % with respect to 100 atom % of the iron atom. From a viewpoint of further preventing the reduction of the reproduction output during the repeated reproduction, the hexagonal strontium ferrite powder contains the iron atom, the strontium atom, the oxygen atom, and the rare earth atom, and a content ratio of the atoms other than these atoms with respect to 100 atom % of the iron atom is preferably 10.0 atom % or less and more preferably in a range of 0 to 5.0 atom %, and may be 0 atom %. That is, in one embodiment, the hexagonal strontium ferrite powder may not contain atoms other than the iron atom, the strontium atom, the oxygen atom, and the rare earth atom. The content ratio expressed in atom % is obtained by converting the content ratio (unit: % by mass) of each atom obtained by totally dissolving the hexagonal strontium ferrite powder into a value expressed in atom % by using the atomic weight of each atom. Furthermore, in the present invention and the present specification, the expression “not contained” for a given atom means that the content ratio thereof obtained by performing total dissolving and measurement with an ICP analysis device is 0% by mass. A detection limit of the ICP analysis device is generally 0.01 ppm (parts per million) or less based on mass. The expression “not contained” is also used to mean that a given atom is contained in an amount smaller than the detection limit of the ICP analysis device. In one embodiment, the hexagonal strontium ferrite powder may not contain a bismuth atom (Bi).

ε-Iron Oxide Powder

In the present invention and the present specification, the “ε-iron oxide powder” refers to a ferromagnetic powder in which an ε-iron oxide-type crystal structure is detected as a main phase by X-ray diffraction analysis. For example, in a case where the diffraction peak of the highest intensity in the X-ray diffraction spectrum obtained by the X-ray diffraction analysis belongs to an ε-iron oxide-type crystal structure, it is determined that the ε-iron oxide-type crystal structure is detected as a main phase. As a producing method of the ε-iron oxide powder, a producing method from goethite, a reverse micelle method, and the like are known. All of the aforementioned producing methods are well known. Moreover, regarding a method for producing the ε-iron oxide powder in which a part of Fe is substituted with a substitutional atom such as Ga, Co, Ti, Al, or Rh, the descriptions disclosed in J. Jpn. Soc. Powder Metallurgy Vol. 61 Supplement, No. S1, pp. S280 to S284, J. Mater. Chem. C, 2013, 1, pp. 5,200 to 5,206, and the like can be referred to, for example. However, the producing method of the ε-iron oxide powder which can be used as the ferromagnetic powder in the magnetic layer of the magnetic recording medium is not limited to the method mentioned above.

An activation volume of the ε-iron oxide powder is preferably in a range of 300 to 1,500 nm³. The atomized ε-iron oxide powder having an activation volume within the above range is suitable for producing a magnetic recording medium exhibiting excellent electromagnetic conversion characteristics. The activation volume of the ε-iron oxide powder is preferably 300 nm³ or greater, and can be, for example, 500 nm³ or greater. Moreover, from a viewpoint of further improving the electromagnetic conversion characteristics, the activation volume of the ε-iron oxide powder is more preferably 1,400 nm³ or less, even more preferably 1,300 nm³ or less, still preferably 1,200 nm³ or less, and still more preferably 1,100 nm³ or less.

The anisotropy constant Ku can be used as an index of reduction of thermal fluctuation, that is, improvement in thermal stability. The ε-iron oxide powder can preferably have Ku of 3.0×10⁴ J/m³ or greater, and more preferably have Ku of 8.0×10⁴ J/m³ or greater. Moreover, Ku of the ε-iron oxide powder can be, for example, 3.0×10⁵ J/m³ or less. However, since a higher Ku means higher thermal stability and thus is preferable, the Ku is not limited to the value exemplified above.

From a viewpoint of increasing reproducing output in a case of reproducing data recorded on a magnetic recording medium, it is desirable that a mass magnetization as of the ferromagnetic powder contained in the magnetic recording medium is high. In regards to this matter, in one embodiment, the as of the ε-iron oxide powder can be 8 A·m²/kg or greater and can also be 12 A·m²/kg or greater. Meanwhile, from a viewpoint of noise reduction, the as of the ε-iron oxide powder is preferably 40 A·m²/kg or less and more preferably 35 A·m²/kg or less.

The content (filling percentage) of the ferromagnetic powder in the magnetic layer is preferably in a range of 50% to 90% by mass and more preferably in a range of 60% to 90% by mass. A higher filling percentage of the ferromagnetic powder in the magnetic layer is preferable from a viewpoint of improving recording density.

Non-Magnetic Powder

The magnetic recording medium may contain a non-magnetic powder in the magnetic layer. The magnetic layer preferably contains, as the non-magnetic powder, at least a non-magnetic powder (hereinafter, referred to as a “projection formation agent”) which can contribute to the formation of projections having a height of 5 nm or higher on the surface of the magnetic layer. Moreover, it is also preferable that the magnetic layer contains, as the non-magnetic powder, a non-magnetic powder (hereinafter, referred to as an “abrasive”) which can function as an abrasive. Hereinafter, the projection formation agent and the abrasive will be further described.

Projection Formation Agent

The projection formation agent may be an inorganic powder or an organic powder. Moreover, as the projection formation agent, carbon black or the like can also be used. Examples of the inorganic powder include powders of an inorganic oxide such as a metal oxide, metal carbonate, metal sulfate, a metal nitride, a metal carbide, a metal sulfide, and the like, and a powder of an inorganic oxide is preferable. In one embodiment, from a viewpoint of uniformization of the friction characteristics, a particle size distribution of the projection formation agent is preferably monodispersion showing a single peak, rather than polydispersion having a plurality of peaks in a particle size distribution. From a viewpoint of ease of availability of monodisperse particles, the projection formation agent is preferably an inorganic powder.

An average particle size of the projection formation agent is, for example, preferably in a range of 90 to 200 nm and more preferably in a range of 100 to 150 nm.

From a viewpoint of further improving the electromagnetic conversion characteristics, it is preferable that a variation in particle sizes of particles of the projection formation agent is small. As an index of the variation in particle sizes, a coefficient of variation (CV) can be used. Here, CV (unit: %)=(σ/ϕ)×100, where ϕ is an average particle size, and can be obtained by the aforementioned method. σ is a standard deviation of particle sizes of 500 particles of which particle sizes are measured in a case of obtaining the average particle size. The CV of the projection formation agent is preferably less than 30.0%, more preferably 20.0% or less, even more preferably 15.0% or less, still preferably 12.0% or less, and still more preferably 10.0% or less. The CV of the projection formation agent can be, for example, 3.0% or greater. However, the smaller variation in the particle size of the projection formation agent is preferable from a viewpoint of further improving the electromagnetic conversion characteristics, and thus the CV may be less than 3.0%.

As a projection formation agent having a small CV, colloidal particles can be used. The “colloidal particles” in the present invention and the present specification refer to particles which can disperse without precipitating to form a colloidal dispersion in a case where, to at least one organic solvent of methyl ethyl ketone, cyclohexanone, toluene, ethyl acetate, or a mixed solvent containing two or more kinds of the aforementioned solvents at an optional mixing ratio, 1 g of the particles per 100 mL of the organic solvent were added. The fact in which the non-magnetic powder contained in the magnetic layer is colloidal particles may be confirmed by evaluating whether or not the non-magnetic powder has properties which meet the aforementioned definition of the colloidal particles in a case where the non-magnetic powder used for forming the magnetic layer is available. Alternatively, the fact can be confirmed by evaluating whether or not the non-magnetic powder extracted from the magnetic layer has properties which meet the aforementioned definition of the colloidal particles. The extraction of the non-magnetic powder from the magnetic layer can be performed, for example, by a method described in paragraph 0045 of JP2017-068884A.

As specific examples of the colloidal particles, colloidal particles of an inorganic oxide such as SiO₂, Al₂O₃, TiO₂, ZrO₂, and Fe₂O₃ can be mentioned, and colloidal particles of a composite inorganic oxide such as SiO₂.Al₂O₃, SiO₂.B₂O₃, TiO₂.CeO₂, SnO₂.Sb₂O₃, SiO₂.Al₂O₃.TiO₂, and TiO₂.CeO₂.SiO₂ can also be mentioned. Moreover, regarding the notation of the composite inorganic oxide, “.” is used to indicate that the compound is a composite inorganic oxide of the inorganic oxides described before and after “.”. For example, SiO₂.Al₂O₃ means a composite inorganic oxide of SiO₂ and Al₂O₃. As the colloidal particles, colloidal particles of silicon dioxide (silica), that is, silica colloidal particles (also referred to as “colloidal silica”) are particularly preferable. Furthermore, regarding the colloidal particles, the descriptions disclosed in paragraphs 0048 and 0049 of JP2017-068884A can also be referred to.

The CV can be an index of the variation in particle sizes. However, the present inventors have thought that the projection formation agent may have coarse particles and/or aggregates with such a low frequency as not to be reflected in the CV and in a case where a magnetic layer is formed of a magnetic layer-forming composition containing the coarse particles and/or aggregates, coarse projections are formed with a low frequency on the magnetic layer. As described above, the present inventors have inferred that such low-frequency coarse projections can be detected by measurement performed using an atomic force microscope with a measurement region of 90 μm square. Moreover, it is thought that the Rpm can be an index of the degree of presence of such low-frequency coarse projections.

In order to remove low-frequency coarse particles and/or aggregates to reduce the Rpm value, it is preferable to perform a centrifugal separation treatment on the dispersion liquid of the projection formation agent. Regarding the centrifugal separation treatment, an S value is set by the following expression using a value expressed in a unit of cm for a diameter d of a particle to be precipitated, and a precipitation time T (seconds) can be calculated by the following expression using the S value, and a K value which is obtained from Rmax and Rmin that are specifications of a rotor of a centrifugal separator and a rotational angular velocity ω (radian (rad)/sec). A time (hereinafter, referred to as a “centrifugal separation treatment time”) for actually performing the centrifugal separation treatment can be set to be T (seconds), T (seconds) or longer, or longer than T (seconds), for example. The centrifugal separation treatment time can be set to, for example, αT (seconds), where a can be 1 or more, and, in order to further remove coarse particles and/or aggregates, is preferably more than 1, more preferably 2 or more, and even more preferably more than 2. The following unit “rpm” is an abbreviation for “revolutions per minute”, which is a unit indicating a rotation speed per minute. Moreover, as ρ1, ρ2, and η, for example, values described in documents such as a handbook and a catalog provided by a manufacturer, or actually measured values can be used.

$${\begin{matrix}S = \frac{{d}^{2} ( ρ2 - ρ1 )}{18 η} \times {10}^{13} \\ K = \frac{ln Rmax - ln Rmin}{3600 {ω}^{2}} \times {10}^{13} \\ T = \frac{K}{S} \end{matrix}}_{\begin{matrix}d \text{:} Diameter ( cm ) of particle \\ ρ1 \text{: Density} ( g \text{/} {cm}^{3} ) of solvent \\ ρ2 \text{: Density} ( g \text{/} {cm}^{3} \text{) of particle} \\ η \text{:} Viscosity ( Poise ) of solvent \\ Rmax \text{:} Maximum rotation radius ( cm ) \\ Rmin \text{: Minimum rotation radius (cm)} \\ N \text{: rotation speed} \text{(rpm)}\end{matrix}}$$

Regarding the particles to be precipitated and removed by the centrifugal separation treatment, the diameter d is preferably set by the following expression: d=ϕ+3σ. As described above, ϕ is an average particle size, and σ is a standard deviation of particle sizes of 500 particles of which particle sizes are measured in a case of obtaining the average particle size. Setting the d by the above expression is preferable from a viewpoint of making it possible to remove low-frequency coarse components having a presence probability of 0.3% or less in the particle size distribution of the projection formation agent.

The content of the projection formation agent in the magnetic layer is preferably 0.1 to 10.0 parts by mass, more preferably 0.1 to 5.0 parts by mass, and even more preferably 1.0 to 5.0 parts by mass, with respect to 100.0 parts by mass of the ferromagnetic powder.

In one embodiment, the number of dark regions having an equivalent circle diameter of 300 μm or greater is preferably less than 5 per an area of 1,490 μm² in a binarized image of a backscattered electron image obtained by imaging the surface of the magnetic layer of the magnetic recording medium with a scanning electron microscope at an acceleration voltage of 2 kV The present inventors have thought that the dark region specified as described above is a projection on the surface of the magnetic layer, which is formed by the projection formation agent. It is inferred that reducing the number of such dark regions to be within the above range may contribute to the reduction of the Rpm value and/or the further improvement in the electromagnetic conversion characteristics. The number is preferably less than 5, more preferably 4 or less, even more preferably 3 or less, still preferably 2 or less, and still more preferably 1 or less. The number can be 0, 0 or more, or more than 0, and is particularly preferably 0.

The number is obtained by the following method.

An SEM image is acquired by a scanning electron microscope (SEM). As the scanning electron microscope, a field emission-scanning electron microscope (FE-SEM) is used. As the FE-SEM, for example, FE-SEM SU8220 manufactured by Hitachi High-Technologies Corporation can be used, and this FE-SEM was used in Examples which will be described later. Moreover, the surface of the magnetic layer is not coated before capturing the SEM image. The SEM image to be acquired is a backscattered electron image.

In imaging conditions, an acceleration voltage is 2 kV, a working distance is 3 mm, and an imaging magnification is 9,000 times. Focus adjustment is performed under the aforementioned imaging conditions, and a backscattered electron image is captured. A backscattered electron image in which a portion (micron bar, cross mark, and the like) displaying a size and the like is erased from the captured image is prepared.

The aforementioned operations are performed 10 times at different portions on the surface of the magnetic layer of the magnetic recording medium to be measured. Therefore, 10 backscattered electron images can be obtained.

The backscattered electron images obtained as described above are taken into image processing software, and subjected to a binarization process. As the image analysis software, for example, free software ImageJ can be used. By the binarization process, the image is divided into a bright region (white portion) and a dark region (black portion). A lower limit value is set to 0 gradations and an upper limit value is set to 75 gradations, and the binarization process is executed by these two threshold values. Before the binarization process, a noise component removal process is performed by the image analysis software. The noise component removal process can be performed by the following method, for example. In the image analysis software ImageJ, a blurring process Gauss Filter is selected to remove noise components.

In the binarized image obtained as described above, for a region (specifically, a region having a size of 14.1 m×10.6 m) having an area of 149 μm² as an area at an actual magnification, the number of dark regions (that is, black portions) and the area of each dark region are obtained by the image analysis software. In the measurement of the number of dark regions, the dark region in which only a part is included in the binarized image and the remaining part is outside the binarized image is excluded from the measurement target. From the area of the dark region obtained here, an equivalent circle diameter of each dark region is obtained. Specifically, an equivalent circle diameter L is calculated by (A/π)\hat{ }(½)×2=L from the obtained area A. Here, the operator “\hat{ }” represents a power.

These steps are performed on the binarized images (10 images) obtained by the aforementioned method, and the total number of dark regions obtained for the 10 images is taken as the number of dark regions per an area of 1,490 μm².

Abrasive

The abrasive is a component capable of exhibiting the ability (abrasive properties) to remove attached substances attached to a magnetic head during running. Examples of the abrasive include powders of alumina (for example, Al₂O₃), silicon carbide, boron carbide (for example, B₄C), titanium carbide (for example, TiC), chromium oxide (for example, Cr₂O₃), cerium oxide, zirconium oxide (for example, ZrO₂), iron oxide, diamond, and the like, which are substances generally used as the abrasive of the magnetic layer, and among them, powders of alumina such as α-alumina, silicon carbide, and diamond are preferable. A content of the abrasive in the magnetic layer is preferably 1.0 to 20.0 parts by mass, more preferably 3.0 to 15.0 parts by mass, and even more preferably 4.0 to 10.0 parts by mass, with respect to 100.0 parts by mass of the ferromagnetic powder. Moreover, regarding a particle size of the abrasive, a specific surface area, which is an index of the particle size, can be, for example, 14 m²/g or greater, preferably 16 μm²/g or greater, and more preferably 18 μm²/g or greater. Furthermore, the specific surface area of the abrasive can be, for example, 40 μm²/g or less.

Binding Agent

The magnetic recording medium can be a coating-type magnetic recording medium, and can contain a binding agent in the magnetic layer. The binding agent is one or more kinds of resins. As the binding agent, various resins generally used as the binding agent of the coating-type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, methyl methacrylate, or the like, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among them, a polyurethane resin, an acrylic resin, a cellulose resin, and a vinyl chloride resin are preferable. The resins may be homopolymers or copolymers. These resins can be used as the binding agent even in the non-magnetic layer and/or a back coating layer which will be described later. Regarding the aforementioned binding agent, the descriptions disclosed in paragraphs 0028 to 0031 of JP2010-024113A can be referred to.

An average molecular weight of the resin used as the binding agent can be, for example, 10,000 to 200,000 as a weight-average molecular weight. The weight-average molecular weight in the present invention and the present specification is a value obtained by performing polystyrene conversion of a value measured by gel permeation chromatography (GPC) under the following measurement conditions. The weight-average molecular weight of the binding agent shown in Examples which will be described later is a value obtained by performing polystyrene conversion of a value measured under the following measurement conditions.

GPC device: HLC-8120 (manufactured by Tosoh Corporation)

Column: TSK gel Multipore HXL-M (manufactured by Tosoh Corporation, 7.8 mmID (inner diameter)×30.0 cm)

Eluent: Tetrahydrofuran (THF)

In addition, a curing agent can also be used together with the resin which can be used as the binding agent. As the curing agent, in one embodiment, a thermosetting compound which is a compound in which a curing reaction (crosslinking reaction) proceeds due to heating can be used, and in another form, a photocurable compound in which a curing reaction (crosslinking reaction) proceeds due to light irradiation can be used. As the curing reaction proceeds in a magnetic layer forming step, at least a part of the curing agent can be contained in the magnetic layer in a state of being reacted (crosslinked) with other components such as the binding agent. In a case where the composition used for forming the other layer contains the curing agent, the above matter is also true of a layer formed of the composition. The preferred curing agent is a thermosetting compound, polyisocyanate is suitable. For details of the polyisocyanate, the descriptions disclosed in paragraphs 0124 and 0125 of JP2011-216149A can be referred to. The curing agent can be used, for example, in an amount of 0 to 80.0 parts by mass with respect to 100.0 parts by mass of the binding agent in the magnetic layer-forming composition, and preferably in an amount of 50.0 to 80.0 parts by mass from a viewpoint of improving hardness of the magnetic layer.

Additive

The magnetic layer may contain one or more kinds of additives, as necessary. As an example of the additives, the aforementioned curing agent can be mentioned. Moreover, examples of the additive contained in the magnetic layer include a lubricant, a dispersing agent, a dispersing assistant, a fungicide, an antistatic agent, and an antioxidant. The additive can be used in any amount by appropriately selecting a commercially available product according to desired properties, or by being produced using a well-known method. Regarding the lubricant, the descriptions disclosed in paragraphs 0030 to 0033, 0035, and 0036 of JP2016-126817A can be referred to, for example. The lubricant may be contained in the non-magnetic layer which will be described later. Regarding the lubricant which may be contained in the non-magnetic layer, the descriptions disclosed in paragraphs 0030, 0031, 0034, 0035, and 0036 of JP2016-126817A can be referred to. Regarding the dispersing agent, the descriptions disclosed in paragraphs 0061 and 0071 of JP2012-133837A can be referred to, for example. Regarding a dispersing agent which can be added to a non-magnetic layer-forming composition, the following description regarding the non-magnetic layer can also be referred to.

Thickness of Magnetic Layer

The thickness of the magnetic layer can be optimized according to a saturation magnetization amount of the magnetic head used, a head gap length, a recording signal band, and the like. The thickness of the magnetic layer is preferably 100 nm or less, more preferably 10 to 100 nm, and even more preferably 20 to 90 nm, from a viewpoint of high-density recording. The magnetic layer may be at least one layer, or the magnetic layer may be separated into two or more layers having different magnetic characteristics, and a configuration regarding a well-known multilayered magnetic layer can be applied. A thickness of the magnetic layer which is separated into two or more layers is a total thickness of the layers.

Non-Magnetic Layer

Thickness of Non-Magnetic Layer

The magnetic recording medium has a non-magnetic layer between the magnetic layer and the non-magnetic support. A thickness of the non-magnetic layer is less than 0.7 μm, preferably 0.6 μm or less, more preferably 0.5 μm or less, and even more preferably 0.4 μm or less. Moreover, the thickness of the non-magnetic layer can be, for example, 0.1 μm or greater. A thin non-magnetic layer is preferable from a viewpoint of increasing the aforementioned number of projections having a height of 5 nm or higher.

Non-Magnetic Powder

As a non-magnetic powder contained in the non-magnetic layer, only one kind of non-magnetic powder may be used, or two or more kinds of non-magnetic powders may be used. As the non-magnetic powder, for example, carbon black can be used. As the carbon black, a commercially available product may be used, or carbon black produced by a well-known method can also be used. Regarding the carbon black, a specific surface area can be used as an index of the particle size. The specific surface area of the carbon black is preferably 280 μm²/g or greater and more preferably 300 μm²/g or greater. The specific surface area of the carbon black is preferably 500 μm²/g or less and more preferably 400 μm²/g or less, from a viewpoint of ease of improving dispersibility. A proportion of the carbon black in the non-magnetic powder of the non-magnetic layer, with respect to the total amount of the non-magnetic powders, is preferably 30.0% by mass or greater, more preferably 40.0% by mass or greater, and even more preferably 50.0% by mass or greater, and may be 60.0% by mass or greater, 70.0% by mass or greater, 80.0% by mass or greater, 90.0% by mass or greater, or 100.0% by mass (that is, only carbon black is used as the non-magnetic powder). Moreover, the proportion of the carbon black in the non-magnetic powder of the non-magnetic layer can be, for example, 90.0% by mass or less or 80.0% by mass or less, with respect to the total amount of the non-magnetic powders. However, as described above, only carbon black may be used as the non-magnetic powder of the non-magnetic layer. The content (filling percentage) of the non-magnetic powder in the non-magnetic layer is preferably in a range of 50% to 90% by mass and more preferably in a range of 60% to 90% by mass.

As a non-magnetic powder other than carbon black, an inorganic powder may be used, or an organic powder may be used. An average particle size of these non-magnetic powders is preferably in a range of 10 to 200 nm and more preferably in a range of 10 to 100 nm.

Examples of the inorganic powder include powders of a metal, a metal oxide, metal carbonate, metal sulfate, a metal nitride, a metal carbide, a metal sulfide, and the like. These non-magnetic powders can be available as a commercially available product or can be produced by a well-known method. For details thereof, the descriptions disclosed in paragraphs 0146 to 0150 of JP2011-216149A can be referred to, for example.

Binding Agent

The non-magnetic layer may contain a binding agent. Regarding the improvement in the dispersibility of the carbon black, according to the studies conducted by the present inventors, it was found that using a vinyl chloride resin as a binding agent tends to be advantageous for improving the dispersibility of the carbon black. Therefore, from a viewpoint of improving the dispersibility of the carbon black, it is preferable to use at least a vinyl chloride resin as the binding agent of the non-magnetic layer, and in a case where a plurality of kinds of resins are used as the binding agent, it is preferable to increase the proportion of the vinyl chloride resin. For example, in one embodiment, the proportion of the vinyl chloride resin with respect to the total amount of the binding agents of the non-magnetic layer is preferably 30.0% by mass or greater, more preferably 50.0% by mass or greater, even more preferably 80.0% by mass or greater, and still preferably 90.0% by mass to 100.0% by mass. Moreover, a content of the binding agent in the non-magnetic layer can be, for example, 10.0 to 40.0 parts by mass with respect to 100.0 parts by mass of the non-magnetic powder.

Additive

The non-magnetic layer may optionally contain one or more kinds of additives. For example, by incorporating an additive (dispersing agent), which contributes to improvement in the dispersibility of the non-magnetic powder in the composition for forming the non-magnetic layer, the dispersibility of the non-magnetic powder in the non-magnetic layer can be improved. As such a dispersing agent, one or more kinds of well-known dispersing agents can be used according to the type of the non-magnetic powder of the non-magnetic layer. For example, as a dispersing agent for carbon black, organic tertiary amine can be mentioned. For the organic tertiary amine, the descriptions disclosed in paragraphs 0011 to 0018 and 0021 of JP2013-049832A can be referred to. Moreover, for the formulation of a composition for increasing the dispersibility of carbon black with organic tertiary amine, the descriptions disclosed in paragraphs 0022 to 0024 and 0027 of JP2013-049832A can be referred to.

The amine is more preferably trialkylamine. The alkyl group included in the trialkylamine is preferably an alkyl group having 1 to 18 carbon atoms. The three alkyl groups included in the trialkylamine may be the same as or different from each other. For details of the alkyl group, the descriptions disclosed in paragraphs 0015 and 0016 of JP2013-049832A can be referred to. As the trialkylamine, trioctylamine is particularly preferable.

For the non-magnetic layer, one or more kinds of other well-known additives can be used in any amount by being appropriately selected from commercially available products according to desired properties, or by being produced using a well-known method.

The non-magnetic layer in the present invention and the present specification also includes a substantially non-magnetic layer containing a small amount of a ferromagnetic powder, for example, as impurities or intentionally, together with the non-magnetic powder.

Here, the substantially non-magnetic layer refers to a layer having a residual magnetic flux density of 10 mT or lower, a layer having a coercivity of 7.96 kA/m (100 Oe) or less, or a layer having a residual magnetic flux density of 10 mT or lower and a coercivity of 7.96 kA/m (100 Oe) or less. It is preferable that the non-magnetic layer does not have a residual magnetic flux density and a coercivity.

Non-Magnetic Support

Next, the non-magnetic support (hereinafter, also simply referred to as a “support”) will be described. Examples of the non-magnetic support include well-known components such as polyethylene terephthalate, polyethylene naphthalate, polyamide such as aromatic polyamide, and polyamide imide, which are subjected to biaxial stretching. Among them, polyethylene terephthalate, polyethylene naphthalate, and polyamide are preferable. These supports may be subjected to corona discharge, a plasma treatment, an easy-bonding treatment, a heat treatment, or the like in advance. A thickness of the non-magnetic support is, for example, in a range of 3.0 to 80.0 μm, preferably in a range of 3.0 to 50.0 μm, and more preferably in a range of 3.0 to 10.0 μm.

Back Coating Layer

The magnetic recording medium may include a back coating layer containing a non-magnetic powder on a surface side of the non-magnetic support opposite to the surface side on which the non-magnetic layer and the magnetic layer are provided. The back coating layer preferably contains any one or both of carbon black and an inorganic powder. For details of the back coating layer, well-known technologies for the back coating layer can be applied. Moreover, the back coating layer may contain a binding agent. Regarding the binding agent contained in the back coating layer and various additives which may be optionally contained in the back coating layer, well-known technologies for the formulation of the magnetic layer and/or the non-magnetic layer can be applied. For example, regarding the back coating layer, the descriptions disclosed in paragraphs 0018 to 0020 of JP2006-331625A and column 4, line 65 to column 5, line 38 of U.S. Pat. No. 7,029,774B can be referred to. A thickness of the back coating layer is preferably 0.90 μm or less and more preferably in a range of 0.10 to 0.70 μm.

Manufacturing Steps

Preparation of Each Layer-Forming Composition

A composition for forming the magnetic layer, the non-magnetic layer, or the back coating layer generally contains a solvent, together with the aforementioned various components. As the solvent, one or more kinds of various solvents generally used for manufacturing a coating-type magnetic recording medium can be used. A content of the solvent in the each layer-forming composition is not particularly limited. For the solvent, the description disclosed in paragraph 0153 of JP2011-216149A can be referred to. A concentration of solid contents and a solvent composition of the each layer-forming composition may be appropriately adjusted according to handling suitability of the composition, coating conditions, and a thickness of each layer to be formed. A step of preparing the composition for forming the magnetic layer, the non-magnetic layer, or the back coating layer can generally include at least a kneading step, a dispersing step, and a mixing step provided before and after these steps, as necessary. Each step may be divided into two or more stages. The centrifugal separation treatment for the dispersion liquid of the projection formation agent is as described above. All raw materials used in the preparation of the each layer-forming composition may be added at the beginning of or during any step. Moreover, each raw material may be dividedly added in two or more steps. For example, the binding agent may be dividedly added in a kneading step, a dispersing step, and a mixing step for adjusting a viscosity after dispersion. In the manufacturing steps of the magnetic recording medium, manufacturing technologies well known in the related art can be used as a part of the steps. In the kneading step, an open kneader, a continuous kneader, a pressure kneader, or a kneader having a strong kneading force such as an extruder is preferably used. For details of the kneading step, the descriptions disclosed in JP1989-106338A (JP-H01-106338A) and JP1989-079274A (JP-H01-079274A) can be referred to. As a disperser, various well-known dispersers using a shearing force, such as a beads mill, a ball mill, a sand mill, or a homomixer, can be used. Dispersion beads can preferably be used for the dispersion. Examples of the dispersion beads include ceramic beads and glass beads, and zirconia beads are preferable. Two or more kinds of beads may be used in combination. A bead diameter (particle diameter) and a bead filling percentage of the dispersion beads are not particularly limited, and may be set according to the powder to be dispersed. The each layer-forming composition may be filtered by a well-known method before being subjected to the coating step. The filtering can be performed with a filter, for example. As the filter used in the filtering, for example, a filter having a pore diameter of 0.01 to 3 μm (for example, a filter made of a glass fiber, a filter made of polypropylene, or the like) can be used.

Coating Step

The non-magnetic layer and the magnetic layer can be formed by sequentially or simultaneously performing multilayer-coating of the non-magnetic layer-forming composition and the magnetic layer-forming composition. The back coating layer can be formed by applying a back coating layer-forming composition onto the surface of the non-magnetic support opposite to the surface on which the non-magnetic layer and the magnetic layer are provided (or the non-magnetic layer and/or the magnetic layer will be provided later). For details of the coating for forming each layer, the description disclosed in paragraph 0066 of JP2010-231843A can be referred to.

Other Steps

Regarding various other steps for manufacturing the magnetic recording medium, the descriptions disclosed in paragraphs 0067 to 0070 of JP2010-231843A can be referred to, for example. For example, regarding an alignment treatment, while a coating layer formed of the magnetic layer-forming composition is in a wet state, the coating layer can be subjected to an alignment treatment in an alignment zone. Regarding the alignment treatment, various well-known technologies such as the description disclosed in paragraph 0052 of JP2010-024113A can be applied. For example, a homeotropic alignment treatment can be performed by a well-known method such as a method using a different polar facing magnet. In the alignment zone, a drying speed of the coating layer can be controlled by a temperature and an air flow of the dry air and/or a transportation rate in the alignment zone. Moreover, the coating layer may be preliminarily dried before being transported to the alignment zone. As an example, a magnetic field strength in the homeotropic alignment treatment can be 0.10 to 0.80 T or 0.10 to 0.60 T. Furthermore, a calender treatment can be performed as a treatment for improving surface smoothness of the magnetic recording medium. Regarding conditions for the calender treatment, for example, the calender pressure (linear pressure) can be 200 to 500 kN/m and is preferably 250 to 350 kN/m. A calender temperature (surface temperature of a calender roll) can be, for example, 70° C. to 120° C. and is preferably 80° C. to 100° C., and a calender speed can be, for example, 50 to 300 m/min and is preferably 50 to 200 m/min.

The magnetic recording medium according to the embodiment of the present invention can be a tape-shaped magnetic recording medium (magnetic tape), and can also be a disk-shaped magnetic recording medium (magnetic disk). For example, the magnetic tape is generally housed in a magnetic tape cartridge, and the magnetic tape cartridge is mounted on a magnetic recording and reproducing device. A servo pattern can be formed on the magnetic recording medium by a well-known method, in order to enable head tracking in the magnetic recording and reproducing device. The “formation of the servo pattern” can also be said to be “recording of a servo signal”. Hereinafter, the formation of the servo pattern will be described using a magnetic tape as an example.

The servo pattern is generally formed along a longitudinal direction of the magnetic tape. Examples of a control (servo control) method using a servo signal include a timing-based servo (TBS), an amplitude servo, or a frequency servo.

As shown in European Computer Manufacturers Association (ECMA)-319 (June 2001), a timing-based servo method is used in a magnetic tape (generally referred to as an “LTO tape”) based on a linear tape-open (LTO) specification. In this timing-based servo method, the servo pattern is formed by continuously disposing a plurality of pairs of magnetic stripes (also referred to as “servo stripes”), which are not parallel to each other, in the longitudinal direction of the magnetic tape. A reason for that the servo pattern is formed with one pair of magnetic stripes, which are not parallel to each other, as described above is to teach a passage position to a servo signal reading element passing on the servo pattern. Specifically, the one pair of the magnetic stripes are formed so that an interval thereof is continuously changed along the width direction of the magnetic tape, and a relative position between the servo pattern and the servo signal reading element can be recognized, by the reading of the interval thereof by the servo signal reading element. The information of this relative position enables the tracking of a data track. Accordingly, a plurality of servo tracks are generally set on the servo pattern along the width direction of the magnetic tape.

A servo band is configured of a servo signal continuous in the longitudinal direction of the magnetic tape. A plurality of servo bands are generally provided on the magnetic tape. For example, the number thereof is 5 in the LTO tape. A region interposed between two adjacent servo bands is referred to as a data band. The data band is configured of a plurality of data tracks and each data track corresponds to each servo track.

In addition, in one embodiment, as shown in JP2004-318983A, information (also referred to as “servo band identification (ID)” or “unique data band identification method (UDIM) information”) indicating servo band numbers is embedded in each servo band. This servo band ID is recorded by shifting a specific pair of servo stripes among the plurality of pairs of servo stripes in the servo band so that the position thereof is relatively displaced in the longitudinal direction of the magnetic tape. Specifically, the method for shifting the specific servo stripe among the plurality of pairs of servo stripes is changed for each servo band. Accordingly, the recorded servo band ID is unique for each servo band, and thus the servo band can be uniquely specified by only reading one servo band by the servo signal reading element.

Furthermore, as a method for uniquely specifying the servo band, a staggered method as shown in ECMA-319 (June 2001) is also used. In this staggered method, a plurality of the groups of one pair of magnetic stripes (servo stripes) not parallel to each other which are continuously disposed in the longitudinal direction of the magnetic tape are recorded so as to be shifted in the longitudinal direction of the magnetic tape for each servo band. A combination of shifting methods between the adjacent servo bands is unique in the entire magnetic tape, and accordingly, the servo band can also be uniquely specified in a case where the servo pattern is read by two servo signal reading elements.

In addition, as shown in ECMA-319 (June 2001), information (also referred to as “longitudinal position (LPOS) information”) indicating the position in the longitudinal direction of the magnetic tape is also generally embedded in each servo band. Similarly to the UDIM information, this LPOS information is also recorded by shifting the position of one pair of servo stripes in the longitudinal direction of the magnetic tape. However, unlike the UDIM information, in this LPOS information, the same signal is recorded in each servo band.

Other information different from the UDIM information and the LPOS information can also be embedded in the servo band. In this case, the embedded information may be different for each servo band, like the UDIM information, or may be common in all of the servo bands, like the LPOS information.

Furthermore, as a method for embedding the information in the servo band, a method other than the aforementioned method can also be used. For example, a predetermined code may be recorded by thinning out a predetermined pair from the group of pairs of the servo stripes.

A servo pattern-forming head is referred to as a servo write head. The servo write head includes pairs of gaps corresponding to the pairs of magnetic stripes, as many as the number of servo bands. In general, a core and a coil are connected to each of the pairs of gaps, and a magnetic field generated in the core can generate a leakage magnetic field in the pairs of gaps, by supplying a current pulse to the coil. In a case of forming the servo pattern, by inputting a current pulse while causing the magnetic tape to run on the servo write head, the magnetic pattern corresponding to the pairs of gaps can be transferred to the magnetic tape to form the servo pattern. A width of each gap can be appropriately set according to a density of the servo pattern to be formed. The width of each gap can be set to, for example, 1 μm or less, 1 to 10 μm, 10 μm or greater, or the like.

Before forming the servo pattern on the magnetic tape, a demagnetization (erasing) process is generally performed on the magnetic tape. This erasing process can be performed by applying a uniform magnetic field to the magnetic tape using a direct current magnet and an alternating current magnet. The erasing process includes direct current (DC) erasing and alternating current (AC) erasing. The AC erasing is performed by gradually reducing an intensity of the magnetic field while reversing a direction of the magnetic field applied to the magnetic tape. Meanwhile, the DC erasing is performed by adding the magnetic field in one direction to the magnetic tape. The DC erasing further includes two methods. A first method is horizontal DC erasing of applying the magnetic field in one direction along a longitudinal direction of the magnetic tape. A second method is vertical DC erasing of applying the magnetic field in one direction along a thickness direction of the magnetic tape.

The erasing process may be performed on the entire magnetic tape, or may be performed for each servo band of the magnetic tape.

A direction of the magnetic field to the servo pattern to be formed is determined according to the direction of erasing. For example, in a case where the horizontal DC erasing is performed on the magnetic tape, the formation of the servo pattern is performed so that the direction of the magnetic field is opposite to the direction of erasing. Accordingly, the output of the servo signal obtained by the reading of the servo pattern can be increased.

Furthermore, as disclosed in JP2012-053940A, in a case where the magnetic pattern is transferred, using the gap, to the magnetic tape subjected to the vertical DC erasing, the servo signal obtained by the reading of the formed servo pattern has a unipolar pulse shape.

Meanwhile, in a case where the magnetic pattern is transferred, using the gap, to the magnetic tape subjected to the horizontal DC erasing, the servo signal obtained by the reading of the formed servo pattern has a bipolar pulse shape.

The magnetic tape is generally housed in a magnetic tape cartridge and the magnetic tape cartridge is mounted on a magnetic recording and reproducing device.

Magnetic Tape Cartridge

Another embodiment of the present invention relates to a magnetic tape cartridge including the aforementioned tape-shaped magnetic recording medium (that is, the magnetic tape).

The details of the magnetic tape included in the magnetic tape cartridge are as described above.

In the magnetic tape cartridge, the magnetic tape is generally housed in a cartridge main body in a state of being wound around a reel. The reel is rotatably comprised in the cartridge main body. As the magnetic tape cartridge, a single reel-type magnetic tape cartridge including one reel in a cartridge main body and a twin reel-type magnetic tape cartridge including two reels in a cartridge main body are widely used. In a case where the single reel-type magnetic tape cartridge is mounted in the magnetic recording and reproducing device in order to record and/or reproduce data on the magnetic tape, the magnetic tape is drawn from the magnetic tape cartridge and wound around the reel on the magnetic recording and reproducing device side. A magnetic head is disposed on a magnetic tape transportation path from the magnetic tape cartridge to a winding reel. Sending and winding of the magnetic tape are performed between a reel (supply reel) on the magnetic tape cartridge side and a reel (winding reel) on the magnetic recording and reproducing device side. In the meantime, the magnetic head and the surface on the magnetic layer side of the magnetic tape come into contact with each other and slide, and accordingly, the recording and/or reproducing of data is performed. Meanwhile, in the twin reel-type magnetic tape cartridge, both reels of the supply reel and the winding reel are provided in the magnetic tape cartridge. The magnetic tape cartridge may be any of the single reel-type magnetic tape cartridge or the twin reel-type magnetic tape cartridge. The magnetic tape cartridge may include the magnetic tape according to the embodiment of the present invention, and well-known technologies can be applied for the other configurations.

Magnetic Recording and Reproducing Device

Still another embodiment of the present invention relates to a magnetic recording and reproducing device including the aforementioned magnetic recording medium.

In the present invention and the present specification, the “magnetic recording and reproducing device” means a device capable of performing at least one of the recording of data on the magnetic recording medium or the reproducing of data recorded on the magnetic recording medium. Such a device is generally referred to as a drive. The magnetic recording and reproducing device can be a sliding-type magnetic recording and reproducing device. The sliding-type magnetic recording and reproducing device is a device in which the surface on the magnetic layer side and the magnetic head come into contact with each other and slide, in a case of performing recording of data on the magnetic recording medium and/or reproducing of the recorded data. For example, the magnetic recording and reproducing device can attachably and detachably include the magnetic tape cartridge.

The magnetic recording and reproducing device may include a magnetic head. The magnetic head can be a recording head capable of performing the recording of data on the magnetic recording medium, and can also be a reproducing head capable of performing the reproducing of data recorded on the magnetic recording medium. Moreover, in one embodiment, the magnetic recording and reproducing device may include both a recording head and a reproducing head as separate magnetic heads. In another embodiment, the magnetic head included in the magnetic recording and reproducing device can also have a configuration in which both an element for recording data (recording element) and an element for reproducing data (reproducing element) are comprised in one magnetic head. Hereinafter, the element for recording data and the element for reproducing data are collectively referred to as “elements for data”. As the reproducing head, a magnetic head (MR head) including, as the reproducing element, a magnetoresistive (MR) element capable of reading data recorded on the magnetic recording medium with excellent sensitivity is preferable. As the MR head, various well-known MR heads such as an anisotropic magnetoresistive (AMR) head, a giant magnetoresistive (GMR) head, and a tunnel magnetoresistive (TMR) head can be used. Furthermore, the magnetic head which performs the recording of data and/or the reproducing of data may include a servo signal reading element. Alternatively, as a head other than the magnetic head which performs the recording of data and/or the reproducing of data, a magnetic head (servo head) comprising a servo signal reading element may be included in the magnetic recording and reproducing device. For example, the magnetic head (hereinafter, also referred to as a “recording and reproducing head”) which performs the recording of data and/or reproducing of the recorded data can include two servo signal reading elements, and each of the two servo signal reading elements can read two adjacent servo bands at the same time. One or a plurality of elements for data can be disposed between the two servo signal reading elements.

In the magnetic recording and reproducing device, the recording of data on the magnetic recording medium and/or the reproducing of data recorded on the magnetic recording medium can be performed by bringing the surface on the magnetic layer side of the magnetic recording medium into contact with the magnetic head and performing sliding. The magnetic recording and reproducing device may include the magnetic recording medium according to the embodiment of the present invention, and well-known technologies can be applied for the other configurations.

For example, in a case of recording data and/or reproducing the recorded data, first, tracking using a servo signal is performed. That is, by causing the servo signal reading element to follow a predetermined servo track, the element for data is controlled to pass on the target data track. The movement of the data track is performed by changing the servo track to be read by the servo signal reading element in the tape width direction.

Furthermore, the recording and reproducing head can also perform the recording and/or reproducing with respect to other data bands. In this case, the servo signal reading element may be moved to a predetermined servo band by using the aforementioned UDIM information, and the tracking with respect to the servo band may be started.

### EXAMPLES

Hereinafter, the present invention will be described with reference to Examples. However, the present invention is not limited to the embodiments shown in Examples. “Parts” described below are based on mass. Moreover, steps and evaluations described below were performed in an environment of an ambient temperature of 23° C.±1° C., unless otherwise noted.

Silica colloidal particles (colloidal silica) used in the following Examples and Comparative Examples were each commercially available silica colloidal particles prepared by a sol-gel method, and had properties which meet the aforementioned definition of the colloidal particles. Coefficients of variation CV of particle sizes and average particle sizes ϕ of these silica colloidal particles shown in Table 1 below are values obtained by the aforementioned methods.

### Example 1

Formulation of Magnetic Layer-Forming Composition

Magnetic Solution
Hexagonal barium ferrite powder (“BaFe” in Table 1): 100.0 parts
   (coercivity Hc: 175 kA/m (2,200 Oe), and average particle size: 27 nm)
Oleic acid: 2.0 parts
Vinyl chloride resin: 10.0 parts
   (MR-104 produced by KANEKA CORPORATION)
Polyurethane resin: 4.0 parts
   (UR-4800 produced by TOYOBO CO., LTD. (sulfonic acid-containing polyester polyurethane resin))
Methyl ethyl ketone: 300.0 parts
Cyclohexanone: 200.0 parts

Abrasive Solution
Alumina powder (α-alumina having a specific surface area of 19 μm²/g): 9.0 parts
Vinyl chloride resin: 0.7 parts
   (MR-110 produced by KANEKA CORPORATION)
Cyclohexanone: 20.0 parts

Silica Sol
Silica colloidal particles (colloidal silica): See Table 1
Cyclohexanone: 4.0 parts

Other Components
Stearic acid: 1.0 part
Stearic acid amide: 0.3 parts
Butyl stearate: 1.5 parts
Methyl ethyl ketone: 110.0 parts
Cyclohexanone: 110.0 parts
Polyisocyanate (CORONATE L produced by Tosoh Corporation): 2.5 parts

Formulation of Non-Magnetic Layer-Forming Composition
Carbon black: 100.0 parts
   (specific surface area: 320 μm²/g, and dibutyl phthalate (DBP) oil absorption amount: 63 cm³/100 g)
Trioctylamine: 4.0 parts
Vinyl chloride resin: 30.0 parts
   (MR-104 produced by KANEKA CORPORATION)
Methyl ethyl ketone: 510.0 parts
Cyclohexanone: 200.0 parts
Stearic acid: 1.5 parts
Stearic acid amide: 0.3 parts
Butyl stearate: 1.5 parts

Formulation of Back Coating Layer-Forming Composition
Carbon black: 100.0 parts
   (average particle size: 40 nm, and DBP oil absorption amount: 74 cm³/100 g)
Copper phthalocyanine: 3.0 parts
Nitrocellulose: 25.0 parts
Polyurethane resin: 60.0 parts
   (UR-8401 produced by TOYOBO CO., LTD. (sulfonic acid-containing polyester polyurethane resin))
Polyester resin: 4.0 parts
   (VYLON 500 produced by TOYOBO CO., LTD.)
Alumina powder (α-alumina having a specific surface area of 17 μm²/g): 1.0 part
Polyisocyanate: 15.0 parts
   (CORONATE L produced by Tosoh Corporation)
Methyl ethyl ketone: 600.0 parts
Toluene: 250.0 parts

Preparation of Each Layer-Forming Composition

The magnetic layer-forming composition was prepared as follows.

The components of the magnetic solution were mixed in a horizontal beads mill disperser to perform a dispersion treatment. In the dispersion treatment, zirconia (ZrO₂) beads (hereinafter, referred to as “Zr beads”) having a particle diameter of 0.1 mm were used, and a retention time per pass at a bead filling percentage of 80% by volume and a rotor tip circumferential speed of 10 m/sec was set to 2 minutes, and the dispersion treatment of 30 passes was performed.

Regarding the abrasive solution, a mixture of the components (the alumina powder, the vinyl chloride resin, and the cyclohexanone) of the aforementioned abrasive solution was prepared, then the mixture was put in the horizontal beads mill disperser together with Zr beads having a particle diameter of 0.3 mm to perform adjustment so that (volume of beads/(volume of abrasive solution+volume of beads))×100 was 80% by volume, a beads mill dispersion treatment was performed for 120 minutes, and the treated solution was extracted and subjected to an ultrasonic dispersion filtering treatment using a flow-type ultrasonic dispersion filtering device.

The silica sol was subjected to a centrifugal separation treatment by setting the aforementioned d and centrifugal separation treatment time to respective values shown in Table 1. The centrifugal separation treatment was performed using centrifugal separator CP100WX manufactured by Hitachi Koki Co., Ltd. and ROTOR P70AT manufactured by Hitachi Koki Co., Ltd. As the d, a value calculated by d=ϕ+3σ was used. In the calculation of T, values described in a catalog provided by a manufacturer were used as ρ1, ρ2, and η. A maximum rotation radius Rmax was set to 9.21 (cm), a minimum rotation radius Rmin was set to 3.90 (cm), and a rotation speed N was set to 10,000 (rpm). In each of Example 1, Examples which will be described later, and Comparative Examples in which the centrifugal separation treatment was performed, the centrifugal separation treatment time was set to a time more than twice the calculated T.

The magnetic solution, the abrasive solution, the silica sol, and other components were introduced into a dissolver stirrer, and stirred for 30 minutes at a circumferential speed of 10 m/sec, subjected to a 3-pass treatment at a flow rate of 7.5 kg/min using a flow-type ultrasonic disperser, and then filtered with a filter having a pore diameter of 1 μm to prepare a magnetic layer-forming composition.

The non-magnetic layer-forming composition was prepared as follows.

The aforementioned components excluding the lubricant (the stearic acid, the stearic acid amide, and the butyl stearate) were mixed in a horizontal beads mill disperser to perform a dispersion treatment. In the dispersion treatment, Zr beads having a particle diameter of 0.1 mm were used, and a retention time per pass at a bead filling percentage of 80% by volume and a rotor tip circumferential speed of 10 m/sec was set to 2 minutes, and the dispersion treatment of 30 passes was performed. Thereafter, the lubricant and the methyl ethyl ketone for adjusting a coating thickness were added, and the mixture was subjected to stirring and mixing treatments using a dissolver stirrer to prepare a non-magnetic layer-forming composition.

In Example 1, and Examples and Comparative Examples which will be described later, in a case of preparing the non-magnetic layer-forming composition, the methyl ethyl ketone for adjusting a coating thickness was used in an amount in a range of 70.0 to 510.0 parts by mass with respect to 100.0 parts by mass of a non-magnetic powder used for preparing the non-magnetic layer-forming composition.

The back coating layer-forming composition was prepared as follows.

The aforementioned components excluding the polyisocyanate were introduced into a dissolver stirrer, stirred for 30 minutes at a circumferential speed of 10 m/sec, and then subjected to the dispersion treatment using a horizontal beads mill disperser. Thereafter, the polyisocyanate was added, and the mixture was subjected to stirring and mixing treatments using a dissolver stirrer to prepare a back coating layer-forming composition.

Production of Magnetic Tape

The non-magnetic layer-forming composition was applied to one surface of a polyethylene naphthalate support having a thickness of 6.0 μm so that the thickness after drying was a thickness shown in Table 1, the composition was dried, then the back coating layer-forming composition was applied to a surface of the support on the opposite side so that the thickness after drying was 0.5 μm, and the composition was dried.

Thereafter, the magnetic layer-forming composition was applied onto the non-magnetic layer so that the thickness after drying was 70 nm, and the composition was dried.

Subsequently, a calender treatment was performed using a calender roll consisting of a metal roll at a speed of 80 m/min, a linear pressure of 300 kg/cm (294 kN/m), and a surface temperature of the calender roll of 100° C., and then a heat treatment was performed for 36 hours in an environment of an ambient temperature of 70° C. After the heat treatment, slitting was performed so that the width was ½ inches (0.0127 meters), to obtain a magnetic tape.

### Examples 2 to 7 and Comparative Examples 1 to 3

Magnetic tapes were produced in the same manner as in Example 1, except that items shown in Table 1 were changed as shown in Table 1.

In Table 1, “SrFe” indicates a hexagonal strontium ferrite powder produced as follows.

1,707 g of SrCO₃, 687 g of H₃B₃, 1,120 g of Fe₂O₃, 45 g of Al(OH)₃, 24 g of BaCO₃, 13 g of CaCO₃, and 235 g of Nd₂O₃ were weighed and mixed using a mixer to obtain a raw material mixture.

The obtained raw material mixture was melted in a platinum crucible at a melting temperature of 1,390° C., a tap hole provided on the bottom of the platinum crucible was heated while stirring the molten liquid, and the molten liquid was tapped in a rod shape at approximately 6 g/sec. The tap liquid was rolled and rapidly cooled using a water-cooling twin roller to produce an amorphous body.

An electric furnace was charged with 280 g of the produced amorphous body, heated to 635° C. (crystallization temperature) at a temperature rising rate of 3.5° C./min, and held at the same temperature for 5 hours, and hexagonal strontium ferrite particles were precipitated (crystallized).

Next, the crystallized material obtained as described above and including the hexagonal strontium ferrite particles was coarsely pulverized with a mortar, 1,000 g of zirconia beads having a particle diameter of 1 mm and 800 mL of an acetic acid aqueous solution having a concentration of 1% were added to a glass bottle containing the coarsely pulverized matter, and a dispersion treatment was performed using a paint shaker for 3 hours. Thereafter, the obtained dispersion liquid was separated from the beads and put in a stainless steel beaker.

The dispersion liquid was allowed to stand at a liquid temperature of 100° C. for 3 hours to perform a dissolving treatment of a glass component, then precipitation with a centrifugal separator was performed, decantation was repeated for washing, and drying was performed in a heating furnace having an in-furnace temperature of 110° C. for 6 hours to obtain a hexagonal strontium ferrite powder.

Regarding the hexagonal strontium ferrite powder obtained as described above, an average particle size was 18 nm, an activation volume was 902 nm³, an anisotropy constant Ku was 2.2×10⁵ J/m³, and a mass magnetization as was 49 A·m²/kg. 12 mg of a sample powder was collected from the hexagonal strontium ferrite powder obtained as described above, the element analysis of a filtrate obtained by partially dissolving this sample powder under the aforementioned dissolving conditions was performed by the ICP analysis device, and a content ratio in the surface layer portion of a neodymium atom was obtained.

Separately, 12 mg of a sample powder was collected from the hexagonal strontium ferrite powder obtained as described above, the element analysis of a filtrate obtained by totally dissolving this sample powder under the aforementioned dissolving conditions was performed by the ICP analysis device, and a bulk content ratio of a neodymium atom was obtained.

The content ratio (bulk content ratio) of the neodymium atom in the hexagonal strontium ferrite powder obtained as described above was 2.9 atom % with respect to 100 atom % of the iron atom. Moreover, the content ratio in the surface layer portion of the neodymium atom was 8.0 atom %. The “content ratio in the surface layer portion/bulk content ratio”, which is the ratio of the content ratio in the surface layer portion to the bulk content ratio, was 2.8, and it was confirmed that the neodymium atoms were unevenly distributed on the surface layers of the particles.

The fact in which the powder obtained as described above shows a crystal structure of the hexagonal ferrite was confirmed by performing scanning with CuKα rays under conditions of a voltage of 45 kV and an intensity of 40 mA, and measuring an X-ray diffraction pattern under the following conditions (X-ray diffraction analysis). The powder obtained as described above showed a magnetoplumbite-type (M-type) crystal structure of hexagonal ferrite. Moreover, a crystal phase detected by the X-ray diffraction analysis was a magnetoplumbite-type single phase.

PANalytical X'Pert Pro diffractometer and PIXcel detector

Soller slit of incident beam and diffraction beam: 0.017 radians

Fixed angle of dispersion slit: ¼ degrees

Mask: 10 mm

Scattering prevention slit: ¼ degrees

Measurement mode: continuation

Measurement time per stage: 3 seconds

Measurement speed: 0.017 degrees per second

Measurement step: 0.05 degrees

In Table 1, “ε-Iron oxide” indicates an ε-iron oxide powder produced as follows.

While stirring, using a magnetic stirrer, a material obtained by dissolving 8.3 g of iron(III) nitrate nonahydrate, 1.3 g of gallium(III) nitrate octahydrate, 190 mg of cobalt(II) nitrate hexahydrate, 150 mg of titanium(IV) sulfate, and 1.5 g of polyvinyl pyrrolidone (PVP) in 90 g of pure water, 4.0 g of an ammonia aqueous solution having a concentration of 25% was added thereto in an air atmosphere under the conditions of an ambient temperature of 25° C., and the mixture was stirred for 2 hours under the temperature condition of the ambient temperature of 25° C. A citric acid aqueous solution obtained by dissolving 1 g of citric acid in 9 g of pure water was added to the obtained solution, and the mixture was stirred for 1 hour. The powder precipitated after the stirring was collected by centrifugal separation, washed with pure water, and dried in a heating furnace having an in-furnace temperature of 80° C.

800 g of pure water was added to the dried powder, and the powder was dispersed in water again to obtain a dispersion liquid. The obtained dispersion liquid was heated to a liquid temperature of 50° C., and 40 g of an ammonia aqueous solution having a concentration of 25% was added dropwise while stirring. The stirring was performed for 1 hour while holding the temperature of 50° C., then 14 mL of tetraethoxysilane (TEOS) was added dropwise, and the mixture was stirred for 24 hours. 50 g of ammonium sulfate was added to the obtained reaction solution, the precipitated powder was collected by centrifugal separation, washed with pure water, and dried in a heating furnace having an in-furnace temperature of 80° C. for 24 hours to obtain a precursor of the ferromagnetic powder.

The obtained precursor of the ferromagnetic powder was loaded into a heating furnace having an in-furnace temperature of 1,000° C. in an air atmosphere and subjected to a heating treatment for 4 hours.

The heat-treated precursor of the ferromagnetic powder was added into a sodium hydroxide (NaOH) aqueous solution having a concentration of 4 mol/L, the liquid temperature was held at 70° C., stirring was performed for 24 hours, and accordingly, a silicic acid compound as an impurity was removed from the heat-treated precursor of the ferromagnetic powder.

Thereafter, by the centrifugal separation treatment, the ferromagnetic powder from which the silicic acid compound was removed was collected and washed with pure water to obtain the ferromagnetic powder.

The composition of the obtained ferromagnetic powder was confirmed by high-frequency inductively coupled plasma-optical emission spectrometry (ICP-OES), and Ga, Co, and Ti substitution-type ε-iron oxide (ε-Ga_{0.28}Co_{0.05}Ti_{0.05}Fe_{1.62}O₃) was obtained.

Furthermore, the X-ray diffraction analysis was performed under the same conditions as those disclosed above for the hexagonal strontium ferrite powder SrFe, and from the peak of the X-ray diffraction pattern, it was confirmed that the obtained ferromagnetic powder has a crystal structure (s-iron oxide-type crystal structure) of a single phase which is an F phase not including a crystal structure of an a phase and a 7 phase.

Regarding the obtained ε-iron oxide powder, an average particle size was 12 nm, an activation volume was 746 nm³, an anisotropy constant Ku was 1.2×10⁵ J/m³, and a mass magnetization as was 16 A·m²/kg.

The activation volumes and anisotropy constants Ku of the aforementioned hexagonal strontium ferrite powder and ε-iron oxide powder are values obtained for each ferromagnetic powder by the aforementioned method using a vibrating sample magnetometer (manufactured by TOEI INDUSTRY CO., LTD.).

Moreover, the mass magnetization as is a value measured using a vibrating sample magnetometer (manufactured by TOEI INDUSTRY CO., LTD.) at a magnetic field strength of 1,194 kA/m (15 kOe).

Evaluation Method

Rpm and Number of Projections Having Height of 5 nm or Higher

In each magnetic tape of Examples and Comparative Examples, a measurement region was set to 90 μm square (90 m×90 m), and the Rpm and the number of projections having a height of 5 nm or higher were obtained by the aforementioned method. Dimension FastScan manufactured by BRUKER was used in a ScanAsyst mode as the AFM, ScanAsyst-AIR manufactured by BRUKER was used as the probe of the AFM, a resolution was set to 1,024 pixels×1,024 pixels, and a scan speed (probe movement speed) was set to 22.8 μm/sec.

Moreover, the 10-spot average roughness Rz specified in JIS B 0601:1994 was also obtained as a reference value, from the shape measurement result of the surface of the magnetic layer obtained through the AFM measurement performed as described above.

Thickness of Non-Magnetic Layer

A sample for observing a cross section was produced by a method described below. The thickness of the non-magnetic layer was obtained by the aforementioned method using the produced sample for observing a cross section. As the field emission-scanning electron microscope (FE-SEM) for SEM observation, FE-SEM S4800 manufactured by Hitachi, Ltd. was used.

(i) A sample of the magnetic tape having a size of 10 mm in the width direction×10 mm in the longitudinal direction was cut out using a razor.

A protective film was formed on a surface of a magnetic layer of the cut-out sample to obtain a sample with a protective film. The protective film was formed by the following method.

A platinum (Pt) film (thickness of 30 nm) was formed on the surface of the magnetic layer of the sample by sputtering. The sputtering of the platinum film was performed under the following conditions.

Sputtering conditions for platinum film

Target: Pt

Vacuum degree in chamber of sputtering device: 7 Pa or less

Current value: 15 mA

A carbon film having a thickness of 100 to 150 nm was further formed on the sample with a platinum film produced as described above. The carbon film was formed by a chemical vapor deposition (CVD) mechanism using a gallium ion (Ga⁺) beam comprised in a focused ion beam (FIB) device used in the section (ii) below.

(ii) The sample with a protective film produced in the section (i) above was subjected to FIB processing using the gallium ion (Ga⁺) beam by the FIB device to expose a cross section of the magnetic tape. In the FIB processing, an acceleration voltage was set to 30 kV and a probe current was set to 1,300 pA.

The sample for observing a cross section exposed as described above was used in the SEM observation for obtaining the thickness of the non-magnetic layer.

Number of Dark Regions Having Equivalent Circle Diameter of 300 μm or Greater

In each magnetic tape of Examples and Comparative Examples, as described above, the number (per an area of 1,490 μm²) of dark regions having an equivalent circle diameter of 300 μm or greater was obtained in a binarized image of a backscattered electron image obtained by imaging the surface of the magnetic layer with a scanning electron microscope at an acceleration voltage of 2 kV. FE-SEM SU8220 manufactured by Hitachi High-Technologies Corporation was used as the FE-SEM, and free software ImageJ was used as the image analysis software. In the noise component removal process, a blurring process Gauss Filter was selected to remove noise components in the image analysis software ImageJ.

Furthermore, as a result of component analysis of the dark region through component analysis (acquisition of a component map) with SEM, it was confirmed that the dark region was colloidal silica.

Electromagnetic Conversion Characteristics

In each magnetic tape of Examples and Comparative Examples, a signal-to-noise ratio (SNR) was measured using a ½-inch (0.0127 meters) reel tester to which the magnetic head was fixed. A magnetic head/magnetic tape relative speed was set to 5.5 m/sec. For recording, a metal-in-gap (MIG) head (gap length of 0.15 μm and track width of 1.0 m) was used, and a recording current was set to the optimum recording current of each magnetic tape. As the reproducing head, a giant-magnetoresistive (GMR) head having an element thickness of 15 nm, a shield interval of 0.1 μm, and a lead width of 0.5 μm was used. A signal having a linear recording density (700 kfci) was recorded, the reproduced signal was measured using a spectrum analyzer manufactured by Shibasoku Co., Ltd., and the ratio of output of a carrier signal to the integrated noise in the entire spectrum was taken as the SNR. In Table 1, SNR is a relative value based on Comparative Example 1 (0.0 dB). Furthermore, the unit kfci is a unit of a linear recording density (cannot be converted to an SI unit system).

Regarding Comparative Example in which the SNR could not be evaluated due to sticking between the surface of the magnetic layer of the magnetic tape and the reproducing head during the evaluation, the SNR is described as “Not measurable” in Table 1.

Measurement of Friction Coefficient

Each magnetic tape of Examples and Comparative Examples was wound around a round bar, which was made of alumina titanium carbide (AlTiC) and had an arithmetic mean roughness Ra of 15 nm and a diameter of 4 mm, as measured using the AFM in 40 μm square (40 μm×40 μm), so that the width direction of the magnetic tape was parallel to the axial direction of the round bar, the magnetic tape was slid by 45 mm per pass at a speed of 14 mm/sec in a state where a weight of 100 g was hung on one end of the magnetic tape and the other end was attached to a load cell, and the sliding of a total of 100 passes was repeated. At this time, a load during sliding of the 1^{st} pass and the 100^{th} pass at a constant velocity was detected by the load cell to obtain a measured value, and friction coefficients of the 1^{st} pass and the 100^{th} pass were calculated based on the following expression.

Friction coefficient=ln(measured value (g)/100 (g))/π

In a case where the friction coefficient could not be evaluated due to sticking between the surface of the magnetic layer of the magnetic tape and the round bar during the measurement, the friction coefficient is described as “Not measurable” in Table 1.

The above results are shown in Table 1.

TABLE 1

| | | Colloidal silica | | | | |
|---|---|---|---|---|---|---|
| | | Average | Coefficients of | | | |
| | Ferromagnetic | particle size | variation | Addition | Silica sol | Non-magnetic layer |
| | powder | ϕ | CV | amount | Centrifugal separation | Thickness |
| | Kind | [nm] | [%] | [parts by mass] | treatment | [μm] |
| Example 1 | BaFe | 130 | 10.0 | 4.0 | d = 170 nm, | 0.4 |
| | | | | | centrifugal separation | |
| | | | | | treatment time: 1 h | |
| Example 2 | BaFe | 130 | 10.0 | 3.0 | d = 170 nm, | 0.4 |
| | | | | | centrifugal separation | |
| | | | | | treatment time: 1 h | |
| Example 3 | BaFe | 130 | 10.0 | 1.0 | d = 170 nm, | 0.4 |
| | | | | | centrifugal separation | |
| | | | | | treatment time: 1 h | |
| Example 4 | BaFe | 130 | 10.0 | 1.0 | d = 170 nm, | 0.1 |
| | | | | | centrifugal separation | |
| | | | | | treatment time: 1 h | |
| Example 5 | BaFe | 100 | 12.0 | 1.0 | d = 140 nm, | 0.1 |
| | | | | | centrifugal separation | |
| | | | | | treatment time: 1 h | |
| Example 6 | SrFe | 130 | 10.0 | 4.0 | d = 170 nm, | 0.4 |
| | | | | | centrifugal separation | |
| | | | | | treatment time: 1 h | |
| Example 7 | ε-Iron oxide | 130 | 10.0 | 4.0 | d = 170 nm, | 0.4 |
| | | | | | centrifugal separation | |
| | | | | | treatment time: 1 h | |
| Comparative | BaFe | 130 | 10.0 | 4.0 | Not measurable | 0.4 |
| Example 1 | | | | | | |
| Comparative | BaFe | 100 | 12.0 | 1.0 | Not measurable | 0.4 |
| Example 2 | | | | | | |
| Comparative | BaFe | 130 | 10.0 | 4.0 | d = 170 nm, | 0.7 |
| Example 3 | | | | | centrifugal separation | |
| | | | | | treatment time: 1 h | |

| | Evaluation result | | | | | | |
|---|---|---|---|---|---|---|---|
| | 90 μm square-AFM | | | SEM observation | | | |
| | measurement result | | | result | | | |
| | | | Number of projections | Number of dark regions | | | |
| | | | having height of 5 nm | having equivalent circle | | | |
| | | (Reference | or higher | diameter of 300 μm | Friction | | |
| | Rpm | value) Rz | [projections/ | or greater | coefficient | | SNR |
| | [nm] | [nm] | 90 μm square] | [dark regions/1,490 μm²] | 1^{st} pass | 100^{th} pass | [dB] |
| Example 1 | 30 | 48 | 6,880 | 4 | 0.17 | 0.30 | 2.2 |
| Example 2 | 25 | 45 | 6,233 | 2 | 0.28 | 0.33 | 2.8 |
| Example 3 | 20 | 41 | 5,032 | 0 | 0.35 | 0.38 | 3.2 |
| Example 4 | 22 | 34 | 6,155 | 1 | 0.32 | 0.35 | 3.0 |
| Example 5 | 20 | 30 | 6,340 | 0 | 0.28 | 0.33 | 3.2 |
| Example 6 | 30 | 48 | 7,220 | 4 | 0.16 | 0.29 | 2.5 |
| Example 7 | 30 | 48 | 7,330 | 4 | 0.15 | 0.28 | 2.5 |
| Comparative | 40 | 55 | 6,920 | 15 | 0.17 | 0.30 | 0.0 |
| Example 1 | | | | | | | (standard) |
| Comparative | 38 | 53 | 6,133 | 10 | 0.35 | 0.38 | 0.3 |
| Example 2 | | | | | | | |
| Comparative | 21 | 51 | 4,211 | 0 | 0.80 | Not | Not |
| Example 3 | | | | | | measurable | measurable |

From the results shown in Table 1, it could be confirmed that the magnetic tapes of Examples have excellent electromagnetic conversion characteristics and friction characteristics.

Moreover, regarding the Rpm and the SNR, there is a correlation that the smaller the Rpm value, the higher the SNR, whereas such a correlation is not seen between the Rz shown as the reference value and the SNR. From the above results, it could be confirmed that controlling the Rpm value is effective for improving the electromagnetic conversion characteristics.

The present invention is useful in the technical field of various magnetic recording media such as a magnetic tape for data storage.

What is claimed is:

1. A magnetic recording medium comprising:
a non-magnetic support;
a non-magnetic layer which contains a non-magnetic powder and is provided on the non-magnetic support; and
a magnetic layer which contains a ferromagnetic powder and is provided on the non-magnetic layer,
wherein a thickness of the non-magnetic layer is less than 0.7 μm, and
an average 5-point peak height Rpm is 30 nm or lower and the number of projections having a height of 5 nm or higher is 5,000 or more, as obtained by using an atomic force microscope in a measurement region of 90 μm square on a surface of the magnetic layer.

2. The magnetic recording medium according to claim 1,
wherein the number of dark regions having an equivalent circle diameter of 300 μm or greater is smaller than 5 per an area of 1,490 μm² in a binarized image of a backscattered electron image obtained by imaging the surface of the magnetic layer with a scanning electron microscope at an acceleration voltage of 2 kV.

3. The magnetic recording medium according to claim 1,
wherein the magnetic layer contains colloidal particles.

4. The magnetic recording medium according to claim 3,
wherein the colloidal particles are silica colloidal particles.

5. The magnetic recording medium according to claim 1,
wherein the thickness of the non-magnetic layer is 0.1 μm to 0.6 am.

6. The magnetic recording medium according to claim 1,
wherein the Rpm is 15 nm to 30 nm.

7. The magnetic recording medium according to claim 1,
wherein the number of projections having a height of 5 nm or higher is 5,000 to 8,000.

8. The magnetic recording medium according to claim 1, further comprising a back coating layer which contains a non-magnetic powder and is provided on a surface side of the non-magnetic support opposite to a surface side on which the non-magnetic layer and the magnetic layer are provided.

9. The magnetic recording medium according to claim 1,
wherein the magnetic recording medium is a magnetic tape.

10. A magnetic tape cartridge comprising the magnetic recording medium according to claim 9.

11. The magnetic tape cartridge according to claim 10,
wherein the number of dark regions having an equivalent circle diameter of 300 μm or greater is smaller than 5 per an area of 1,490 μm² in a binarized image of a backscattered electron image obtained by imaging the surface of the magnetic layer with a scanning electron microscope at an acceleration voltage of 2 kV.

12. The magnetic tape cartridge according to claim 10,
wherein the thickness of the non-magnetic layer is 0.1 μm to 0.6 μm.

13. The magnetic tape cartridge according to claim 10,
wherein the Rpm is 15 nm to 30 nm.

14. The magnetic tape cartridge according to claim 10,
wherein the number of projections having a height of 5 nm or higher is 5,000 to 8,000.

15. A magnetic recording and reproducing device comprising the magnetic recording medium according to claim 1.

16. The magnetic recording and reproducing device according to claim 15,
wherein the number of dark regions having an equivalent circle diameter of 300 μm or greater is smaller than 5 per an area of 1,490 μm² in a binarized image of a backscattered electron image obtained by imaging the surface of the magnetic layer with a scanning electron microscope at an acceleration voltage of 2 kV.

17. The magnetic recording and reproducing device according to claim 15, wherein the thickness of the non-magnetic layer is 0.1 μm to 0.6 μm.

18. The magnetic recording and reproducing device according to claim 15, wherein the Rpm is 15 nm to 30 nm.

19. The magnetic recording and reproducing device according to claim 15, wherein the number of projections having a height of 5 nm or higher is 5,000 to 8,000.
